(19) United States
(12) Patent Application Publication
(10) Pub. No.: US 2026/0112383 A1
(43) Pub. Date: Apr. 23, 2026

(54) System and Method for Task-Aware Unified Source Separation

(71) Applicant: Mitsubishi Electric Research Laboratories, Inc., Cambridge, MA (US)

(72) Inventors: Jonathan Le Roux, Arlington, MA (US); Kohei Saijo, Cambridge, MA (US); Gordon Wichern, Boston, MA (US); François G Germain, Quincy, MA (US); Janek Ebbers, Cambridge, MA (US)

(73) Assignee: Mitsubishi Electric Research Laboratories, Inc., Cambridge, MA (US)

(21) Appl. No.: 19/094,847

(22) Filed: Mar. 29, 2025

Related U.S. Application Data
(60) Provisional application No. 63/710,810, filed on Oct. 23, 2024.

(51) Int. Cl. G10L 21/0272; G10L 25/30

(52) U.S. Cl. CPC G10L 21/0272; G10L 25/30

(57) ABSTRACT

Embodiments disclosing an audio processing system for isolating and extracting a varying number of sound sources from an audio mixture are provided. The audio processing system includes a prompt input interface configured to produce a set of input digital encodings representing input sound prompts of at least some of the sound sources forming the audio mixture in a space of the features of the audio mixture. The set of input digital encodings includes a set of target digital encodings representing target sound prompts for extracting target sound sources from the audio mixture. An information exchanger neural network is trained to modify each of the set of target digital encodings and the features of the audio mixture. An extraction neural network is trained to extract a varying number of the target sound sources by processing the modified target digital encodings and the modified features of the audio mixture.

### TECHNICAL FIELD

The present disclosure relates generally to audio processing, and more specifically to a task-aware audio processing system for source separation.

### BACKGROUND

With the advent of neural network-based approaches, high-fidelity audio source separation systems have been developed for multiple applications. Source separation has historically been formulated as one of several sub-tasks, such as speech enhancement (SE), speech separation (SS), music source separation (MSS), and universal sound separation (USS). Recently, the task of separating a mixture into the broader categories of speech, music, and sound effects (SFX) was introduced as cinematic audio source separation (CASS), also known as the cocktail fork problem.

In some cases, all the sources in a mixture need to be separated, while in others desired stems may themselves be mixtures of multiple sources, such as in CASS, the noise stem in SE, or the “others” stem in MSS. In most cases, separation models are trained on specific datasets and address only a specific type of task.

Some models like the general audio source separation (GASS) aim to develop a single model that can separate arbitrary sources. While USS originally aims to separate arbitrary sources, it has so far been mostly limited to the separation of predominantly sound event sources. GASS provides for the separation of mixtures that may contain speech, music, and/or sound events. Some single separation models that can separate speech, musical instruments, and environmental sounds well could be obtained by training on large-scale data. These models have a fixed number of outputs and need to be fine-tuned on each downstream task to achieve satisfactory performance. This is because the source separation problem is inherently ill-posed, and its goal is task specific. In particular, it is challenging for a single task-agnostic model such as in GASS to manage tasks with contradictory goals (e.g., CASS where music sources need to be grouped and MSS where they need to be separated), as it may not be known what source to separate.

Another type of source separation relies on conditional models. Conditional models have been mainly developed so far for target sound extraction (TSE), specifying a target source using a cue such as a speaker utterance or sound recording, or specifying a target sound event class (or group thereof) using class IDs. However, unlike normal unconditional separation models, TSE models extract only one source or one group of sources as a single output, and they do not explicitly model the relationship between the target source and the other sources.

One way to manage some contradictory tasks is via hierarchical separation, where the model has multiple prediction heads, for example, to estimate category-wise mixtures and individual sources. Such methods, however, also have a fixed number of outputs for individual sources (just one for each source or one for each category).

There is a need to go beyond these limitations and truly address all the major source separation tasks mentioned earlier.

Therefore, there is a need for improved methods of target source separation in audio processing systems.

### SUMMARY

Several attempts have been made to manage multiple source separation tasks such as speech enhancement, speech separation, sound event separation, music source separation (MSS), or cinematic audio source separation (CASS) with a single model. These models are trained on large-scale data including speech, instruments, or sound events and can often successfully separate a wide range of sources. However, it is still challenging for such models to cover all separation tasks because some of them are contradictory (e.g., musical instruments are separated in MSS while they have to be grouped in CASS). They also cannot elegantly manage a varying number of output sources, having to rely on a fixed number of sources, typically a maximum number of expected sources. To overcome these issues and support all the major separation tasks, the present disclosure proposes a task-aware unified source separation (TUSS) model. The TUSS model uses a variable number of prompts to specify which source to separate, and changes its behavior depending on the given prompts, enabling it to manage all the major separation tasks including contradictory ones, as well as new combinations of prompts unseen during training.

Some embodiments are based on a recognition that the proposed TUSS model successfully manages the five major separation tasks mentioned earlier. Some embodiments disclose use of audio examples, including both synthetic mixtures and real recordings, to demonstrate how flexibly the TUSS model changes its behavior at inference depending on the prompts, based on user needs and choices.

Unlike traditional source separation and TSE models, the embodiments disclosed herein for the proposed model accept a variable number of prompts and output simultaneously the corresponding number of separated sources. This allows the model to use the information from other prompts to improve the separation of a given prompt, and to output the desired number of sources in a single run of the model. The model can also manage at inference time new combinations of sources that were not seen during training.

In some embodiments, the model features prompts to obtain an individual source (e.g., SFX, or bass) as well as a mixture of sources (e.g., SFX-mix or Music-mix), which allows it to manage all the tasks including CASS.

According to some embodiments, an audio processing system is disclosed. The audio processing system is configured to isolate and extract a varying number of sound sources from an audio mixture. The audio processing system comprises a processor coupled with stored instructions that, when executed by the processor, run modules of the audio processing system, the modules comprising an audio input interface configured to produce features of an audio mixture formed by multiple sound sources. The modules also include a prompt input interface configured to produce a set of input digital encodings representing input sound prompts of at least some of the sound sources forming the audio mixture in a space of the features of the audio mixture. The set of input digital encodings includes a set of target digital encodings representing target sound prompts for extracting target sound sources from the audio mixture. The modules include an information exchanger neural network trained to modify each of the set of target digital encodings, and the features of the audio mixture based on the input digital encodings and the features of the audio mixture. The modules also include an extraction neural network trained to extract a varying number of the target sound sources by processing the modified target digital encodings and the modified features of the audio mixture. Additionally, the modules include an output interface configured to output the extracted target sound sources.

According to some embodiments, a method for processing an audio mixture is provided. The method includes producing features of the audio mixture formed by multiple sound sources. The method also includes producing a set of input digital encodings representing input sound prompts of at least some of the sound sources forming the audio mixture in a space of the features of the audio mixture. The set of input digital encodings includes a set of target digital encodings representing target sound prompts for extracting target sound sources from the audio mixture. The method further includes modifying the target digital encodings and the features of the audio mixture based on the input digital encodings and the features of the audio mixture. The method also includes extracting a varying number of the target sound sources by processing the modified target digital encodings and the modified features of the audio mixture. Additionally, the method includes outputting the extracted target sound sources.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of an audio processing system for separating target sound sources, according to various embodiments of the present disclosure.

FIG. 1B illustrates a block diagram showing details of different modules of the audio processing system of FIG. 1A, according to an embodiment of the present disclosure.

FIG. 1C illustrates a block diagram of a mode of operation of the audio processing system, according to an embodiment of the present disclosure.

FIG. 1D illustrates a block diagram of another mode of operation of the audio processing system, according to an embodiment of the present disclosure.

FIG. 1E illustrates a block diagram showing another mode of operation of the audio processing system, according to an embodiment of the present disclosure.

FIG. 1F illustrates a block diagram showing yet another mode of operation of the audio processing system, according to an embodiment of the present disclosure.

FIG. 2A illustrates a block diagram of an architecture of operation of the audio processing system and its various modules, according to various embodiments of the present disclosure.

FIG. 2B illustrates a block diagram showing training of the audio processing system, according to an embodiment of the present disclosure.

FIG. 2C illustrates a block diagram showing further details for training of the audio processing system, according to an embodiment of the present disclosure.

FIG. 2D illustrates a block diagram showing lists of various tasks and corresponding prompts considered during training, as well as the associated datasets for each prompt category from which audio samples are sampled, according to an embodiment of the present disclosure.

FIG. 2E illustrates a table showing some hyperparameters notations and definitions for training the audio processing system, according to an embodiment of the present disclosure.

FIG. 3A illustrates a block diagram showing details of the encoder, according to an embodiment of the present disclosure.

FIG. 3B illustrates a block diagram showing details of the information exchanger or cross-prompt module, according to an embodiment of the present disclosure.

FIG. 3C illustrates an example architecture of the extraction neural network, according to an embodiment of the present disclosure.

FIG. 3D illustrates a block diagram showing details of different architectures of the decoder, according to an embodiment of the present disclosure.

FIG. 3E illustrates a block diagram showing details of the prompt input interface, according to an embodiment of the present disclosure.

FIG. 4 illustrates a block diagram of the audio processing system that can use combinations of prompts never seen during training, according to an embodiment of the present disclosure.

FIG. 5A illustrates a block diagram showing prompt dropout training of the audio processing system, according to an embodiment of the present disclosure.

FIG. 5B illustrates a block diagram showing how the audio processing system may be used to extract only a subset of the sources or groups of sources present in a mixture, according to an embodiment of the present disclosure.

FIG. 6 illustrates an example user interface through which a use may interact with the audio processing system, according to an embodiment of the present disclosure.

FIG. 7A illustrates a schematic showing how the audio processing system may be expanded to use other types of prompts beyond tokens indicating sound categories, according to an embodiment of the present disclosure.

FIG. 7B illustrates how the audio processing system can also use a joint text-audio embedding, according to an embodiment of the present disclosure.

FIG. 8 illustrates a schematic showing how the audio processing system may be used as part of a system that fully separates a mixture signal without manual specification of the number and type of sources by a user, according to an embodiment of the present disclosure.

FIG. 9 illustrates a flow chart depicting a method for target sound sources extraction according to various embodiments of the present disclosure.

FIG. 10 is a block diagram of the audio processing system for performing audio signal processing, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art that fall within the scope and spirit of the principles of the presently disclosed embodiments.

### DETAILED DESCRIPTION

The following description provides exemplary embodiments only and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the following description to provide a thorough understanding of the embodiments. However, understood by one of the ordinary skills in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

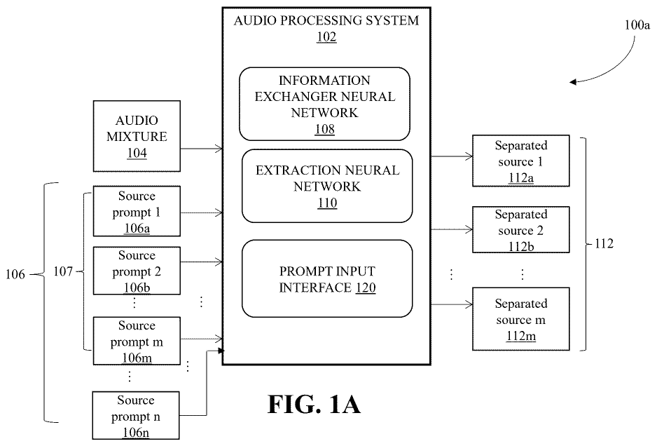

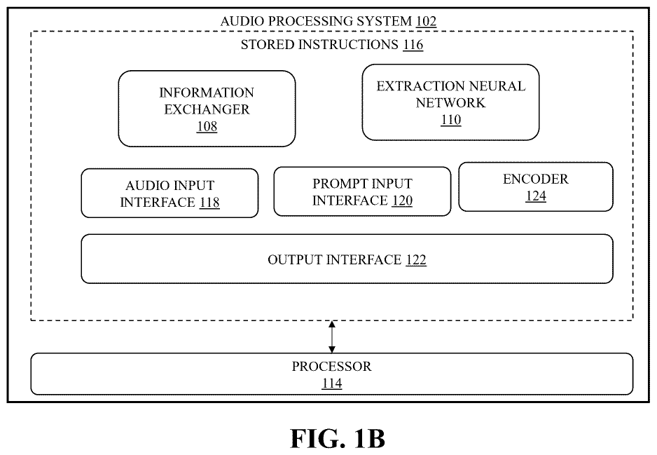

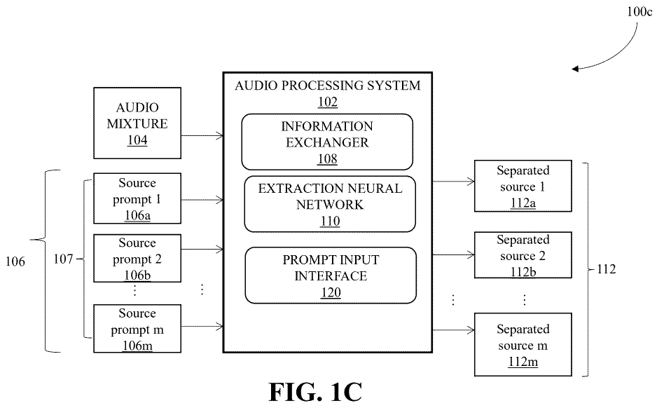

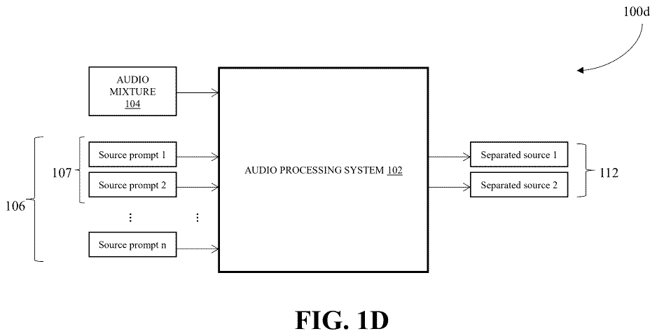

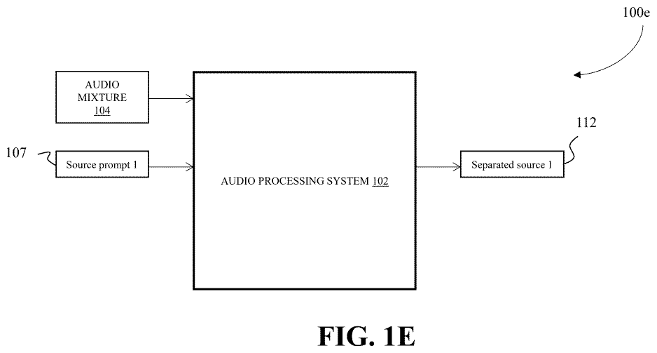

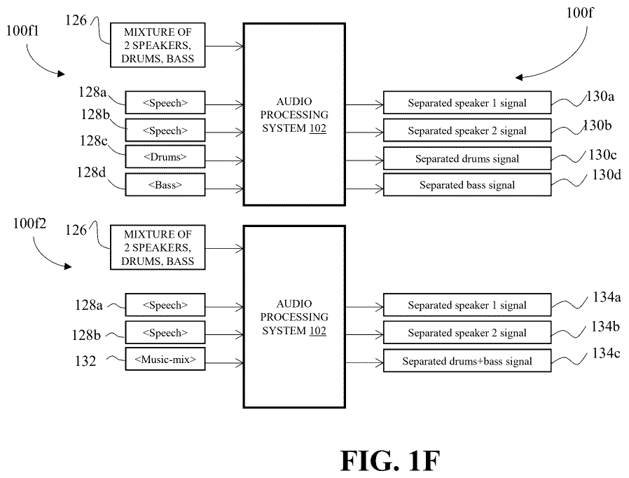

FIG. 1A illustrates a block diagram 100a of an audio processing system 102 for separating target sound sources, according to various embodiments of the present disclosure.

The audio processing system 102 is configured to isolate and extract a varying number of sound sources from an audio mixture 104. To that end, the audio processing system 102 comprises a processor coupled with stored instructions that, when executed by the processor, run some modules of the audio processing system 102, the modules configuring the audio processing system 102 to perform the operations required for isolation and extraction of the varying number of sound sources.

The audio processing system 102 is configured to collect and/receive a varying number of input sound prompts 106, which further include a varying number of target sound prompts 107. The varying number of input sound prompts 107 are processed through the various modules of the audio processing system 102 which include an information exchanger neural network 108, an extraction neural network 110, and a prompt input interface 120.

As used herein, a varying number of sound sources means that the audio system 102 is not constrained to extract a fixed number of sound sources. Instead, the audio processing system 102 may extract different numbers or types of sound sources from the same and/or different audio mixtures, depending on the execution. To facilitate this, the audio processing system 102 is configured to accept a varying number of input prompts indicating the presence or types of sound sources in an audio mixture, as well as a varying number of target prompts indicating which specific sound sources 112 are to be extracted from the mixture.

In some embodiments, the set of target prompts 107 is a subset of the set of input prompts 106. That is, every target prompt is also an input prompt, although not every input prompt necessarily serves as a target prompt. In some implementations, all input prompts are used as target prompts. Alternatively, the target prompts may form a strict subset of the input prompts.

As a result of the functioning of the various modules, the audio processing system 102 outputs simultaneously a corresponding number of separated sources 112, where the number of separated sources 112 corresponds to the number of target sound prompts 107. The separated sources include, for example, a separated source 112a, a separated source 112b, a separated source 112m, (also referred to hereinafter as sound sources 112a-112m) and the like. The system may output more sources than the three sources shown in an embodiment, without deviating from the scope of the present disclosure.

In various embodiments, the audio processing system 102 is configured to isolate and extract a varying number of sound sources 112 from an audio mixture 104. To that end, the system includes an extraction neural network 110 trained to extract a varying number of sound sources 112 by processing the audio mixture 104 and/or features derived therefrom, in accordance with one or more target prompts 107.

However, certain embodiments recognize limitations inherent in such a direct extraction approach. To address these limitations, the audio processing system 102 further includes a prompt input interface 120, which is configured to generate a set of input digital encodings representing input sound prompts corresponding to at least some of the sound sources present in the audio mixture. These encodings are generated within the same feature space as that of the audio mixture. The system also includes an information exchanger neural network 108, which is trained to modify both the set of target digital encodings and the features of the audio mixture based on the input digital encodings and the features of the audio mixture.

The role of the prompt input interface 120 is to transform the input sound prompts 106 (and accordingly the target prompts 107) into digital encodings that reside in the feature space used by the extraction neural network 110. In some embodiments, the prompt input interface 120 accepts pre-encoded digital representations of various sound prompts, either instead of or in addition to receiving indicators specifying the function or purpose of the prompt. Additionally, or alternatively, some embodiments store predetermined digital encodings corresponding to different types of sound prompts in a memory accessible by the audio processing system 102. In such embodiments, the prompt input interface 120 may receive textual or voice-based indications of the input and/or target prompts and retrieve the corresponding digital encodings from memory.

The function of the information exchanger neural network 108 is to facilitate information exchange between the audio mixture features and the digital encodings of the input/target prompts in a manner that improves the quality or effectiveness of sound source extraction. To this end, some embodiments implement mutual modification, wherein the audio mixture features are modified based on the digital encodings of the input prompts, and conversely, the digital encodings are refined based on the features of the audio mixture. Such mutual influence can be implemented, for example, using attention mechanisms.

In this manner, the extraction neural network 110 does not process the raw audio mixture features and original prompt encodings directly but instead operates on the modified audio mixture features and the modified digital encodings of the input/target prompts. Accordingly, in various embodiments, the extraction neural network 110 is trained to extract a varying number of target sound sources based on these modified inputs.

The detailed architecture of the audio processing system 102 with various modules is discussed in detail in FIG. 1B.

FIG. 1B illustrates a block diagram showing a detailed architecture of the audio processing system 102 of FIG. 1A, according to an embodiment of the present disclosure. FIG. 1B is explained in conjunction with elements of FIG. 1A. The audio processing system 102 includes different modules that are blocks of data stored in the form of stored instructions 116. The stored instructions 116 are executed by a processor 114, which causes the modules of the stored instructions 116 to perform operations that enable the audio processing system 102 to perform its functionality.

The processor 114, as used herein, refers to any processing unit capable of executing instructions stored in memory to perform operations associated with the audio processing system 102 of the present disclosure. The processor 114 may include a single-core or multi-core CPU, microcontroller, DSP, ASIC, FPGA, or SoC. The processor 114 may execute software or firmware instructions stored in volatile or non-volatile memory to perform data processing, control logic execution, or communication handling. The processor 114 may also incorporate specialized components such as GPUs, AI accelerators, or encryption modules to enhance performance and security. The processor 114 may communicate with peripheral devices, sensors, or networks via wired or wireless interfaces and operate under an operating system or real-time environment in some embodiments. The processor 114 with its different capabilities causes execution of different modules which include—the information exchanger neural network 108, the extraction neural network 110, an audio input interface 118, the prompt input interface 120, and an encoder 124.

The audio input interface 118 is configured to collect the audio mixture 104 formed by multiple sound sources. The multiple sound sources may include speech, natural sounds or sound effects (SFX), drums, bass, vocals, musical instruments, and the like. The audio input interface 118 may include a component or subsystem configured to facilitate the transmission, conversion, processing, or routing of audio signals within the audio processing system 102. The audio input interface 118 may include analog-to-digital converters (ADC) and digital-to-analog converters (DAC) to enable signal conversion between analog and digital domains. The audio input interface 118 may further comprise input and output ports, such as XLR, TRS, RCA, USB, or optical interfaces, for connecting microphones, speakers, instruments, or external devices. In some embodiments, the audio input interface 118 may incorporate signal processing functions, such as preamplification, gain control, equalization, or effects processing. The audio input interface 118 may also support digital communication protocols, including USB Audio, MIDI, Dante, AVB, or AES67, and the like, to enable integration with external systems. Additionally, the audio input interface 118 may include wireless communication modules or network interfaces for transmitting audio data over wired or wireless connections from the audio processing system 102. In some embodiments, the audio input interface 118 comprises a graphical user interface (GUI). The GUI may include interactive elements such as sliders, dropdown menus, checkboxes, input boxes, buttons, and real-time visual meters to facilitate user customization and monitoring of incoming audio signals. The audio input interface 118 collects the audio mixture 104 at its input and produces features of the audio mixture 104 at its output. The audio input interface 118 receives the audio mixture 104 and processes it through a feature extraction pipeline. The system applies signal decomposition techniques, such as Short-Time Fourier Transform (STFT) or wavelet transforms, to extract time-frequency representations. It further computes key audio features, including spectral coefficients, pitch, energy, and phase information. The extracted features are then encoded into a structured numerical format suitable for downstream processing, such as machine learning models or signal enhancement systems.

The modules of the audio processing system 102 further include the prompt input interface 120 configured to collect an input set of sound prompts 106 designated as input sound prompts (hereinafter the terms input set of sound prompts 106 and input sound prompts 106 would be used interchangeably to mean the same), the input set of sound prompts 106 including a target set of sound prompts 107 designated as target sound prompts (hereinafter the terms target set of sound prompts 107 and target sound prompts 107 would be used interchangeably to mean the same), each of the input sound prompts 106 including one or a combination of a learned embedding vector indicative of a reference sound sample, a speaker utterance, and a sound event class to indicate one of the multiple sound sources in the audio mixture 104. For example, the input sound prompts 106 include a sound prompt 106a, a sound prompt 106b, and a sound prompt 106m, and a sound prompt 106n, where m and n are any exemplary whole numbers. The target sound prompts 107 include a sound prompt 106a, a sound prompt 106b, and a sound prompt 106m. It may be noted that the target sound prompts 107 are a subset of the input sound prompts 106. To that end, m<=n. When m=n, the input sound prompts 106 and the target sound prompts 107 are same. However, in an embodiment, when m<n, the target sound prompts 107 are a strict subset of the input sound prompts 106.

In an embodiment, the input sound prompts 106 includes multiple sound prompts and each of the sound prompts in the input sound prompts 106 is indicated as a target sound prompt.

In an embodiment, the input sound prompts 106 include multiple sound prompts, and a strict subset of sound prompts from the input sound prompts 106 are indicated as target sound prompts 107 (as shown in FIG. 1A), with one or more input sound prompts not in the target set of sound prompts.

In an embodiment, a sound prompt includes an audio-based input provided to the audio processing system 102 to trigger a response, initiate processing, or guide output generation. The sound prompt may comprise speech, tonal signals, musical patterns, ambient noise, or other auditory cues. In some embodiments, the sound prompts may comprise tokens each indicative of a class or type of a sound. In some embodiments, the sound prompt may be a command, predefined or not, such as a spoken phrase, wake word, or acoustic signal, which activates or directs the system. The sound prompt may also include complex auditory patterns, such as melodies, rhythmic sequences, or environmental sounds, which are analyzed for feature extraction, classification, or response generation. The audio processing system 102 may process each sound prompt of the input sound prompts 106 or the target sound prompts 107 using machine learning models, signal processing algorithms, or neural networks to extract relevant features, interpret intent, or generate corresponding outputs. In some embodiments, each sound prompt may be dynamically modified, combined with other data inputs, or used in conjunction with visual or textual prompts to enhance functionality of the audio processing system 102.

In an embodiment, the input sound prompts 106 comprise eight categories of sound prompts: <Speech>, <SFX>, <SFX-mix>, <Drums>, <Bass>, <Vocals>, <Other inst.>, and <Music-mix>. The <*-mix>prompts are for grouping all the sources from that category, while the others are for extracting individual sources.

In an embodiment, the input sound prompts 106 and the target sound prompts 107 are associated with learnable digital encodings, and are accepted by the prompt input interface 120 and/or retrieved from the memory. The learnable sound prompt is dynamically optimized or adapted through training to enhance system performance, response accuracy, or contextual understanding. The audio processing system 102 may implement prompt tuning techniques, such as embedding optimization, prefix tuning, or reinforcement learning, to enhance the adaptability of the sound prompt. Additionally, the learnable sound prompt may be contextually modified based on prior interactions, environmental conditions, or user-specific preferences to improve functionality in applications such as voice assistants, generative audio systems, or interactive multimedia platforms.

The prompt input interface 120 receives the input sound prompts 106 and the target sound prompts at its input and processes them to generate a set of input digital encodings representing the input sound prompts 106 and, correspondingly, a set of target digital encodings representing the target sound prompts 107. The set of input digital encodings includes the set of target digital encodings, which specify the target sound prompts 107 used for extracting the corresponding target sound sources from the audio mixture 104.

The input digital encodings (hereinafter, the terms set of input digital encodings and input digital encodings are used interchangeably) and the target digital encodings (hereinafter, the terms set of target digital encodings and target digital encodings are used interchangeably) are constructed to reside in the same feature space as the features of the audio mixture 104. Accordingly, the information exchanger neural network 108 and the extraction neural network 110 operate on these digital encodings of the input and target prompts, as produced by the prompt input interface 120.

The audio processing system 102 further includes the information exchanger neural network 108, which is trained to modify the target sound prompts 107 and features derived from the audio mixture 104 based on the input sound prompts 106 and the features derived from the audio mixture 104.

The audio processing system 102 also includes the extraction neural network 110, that is trained to extract a varying number of target sound sources corresponding to the target sound prompts 107 by processing the modified digital encodings of the target sound prompts and the modified features derived from the audio mixture 104.

In an embodiment, the audio processing system 102 accepts a variable number of prompts as the target sound prompts 107 and outputs simultaneously the corresponding number of separated sources 112. The separated sources include, for example, a separated source 112a, a separated source 112b, a separated source 112m, (also referred to hereinafter as sound sources 112a-112m) and the like. To that end, the audio processing system 102 provides as output, as many number of separated sources 112, as the number of designated target sound prompts 107, in one embodiment. This allows the audio processing system 102 to use the information from other prompts and to manage the separation of multiple sources from the same class beyond the classical speech separation case. The audio processing system 102 may feature prompts to obtain an individual source (e.g., SFX) as well as a mixture of sources (e.g., SFX-mix), which allows it to manage all the audio tasks including CASS. To that end, the audio processing system 102 successfully manages multiple tasks allowing a user to flexibly control the desired outputs for a given mixture at inference time.

In some embodiments, the audio processing system 102 is also able to process combinations of sound prompts unseen during training.

The modules of the audio processing system 102 also include the output interface 122 configured to output varying number of extracted or separated target sound sources 112.

The audio processing system 102 is configured to isolate and extract the varying number of sound sources 112a-112m from the audio mixture 104. The output interface 122 is configured to output the varying number of extracted sound sources 112. To that end, the output interface 122 facilitates the transmission, conversion, or delivery of processed audio signals to one or more output devices. The output interface 122 may include analog or digital signal transmission components, such as digital-to-analog converters (DACs), amplifiers, equalizers, or signal conditioning circuits, to optimize audio quality and compatibility with downstream devices. In some embodiments, the output interface 122 may comprise wired or wireless communication modules, including but not limited to TRS, XLR, RCA, optical, USB, Bluetooth, Wi-Fi, or network-based protocols such as AES67, AVB, or Dante, and the like. The output interface 122 may further support multi-channel audio output, spatial audio rendering, or adaptive processing based on environmental factors or user preferences. Additionally, the output interface 122 may include real-time signal monitoring, error correction, or format conversion functionalities to ensure optimal audio delivery. In certain implementations, the output interface 122 may be integrated with a control system to adjust parameters such as volume, equalization, or spatialization dynamically based on feedback from connected devices or user input. In some embodiments, the output interface 122 comprises a graphical user interface (GUI). The GUI may include interactive elements such as sliders, dropdown menus, checkboxes, input boxes, buttons, and real-time visual meters to facilitate user customization and monitoring of incoming audio signals.

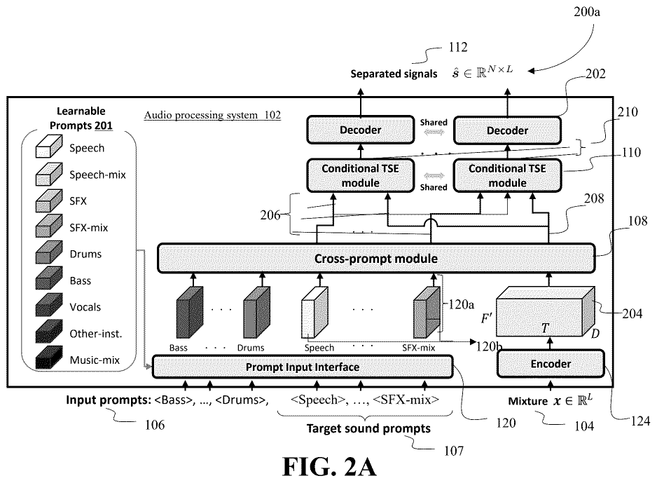

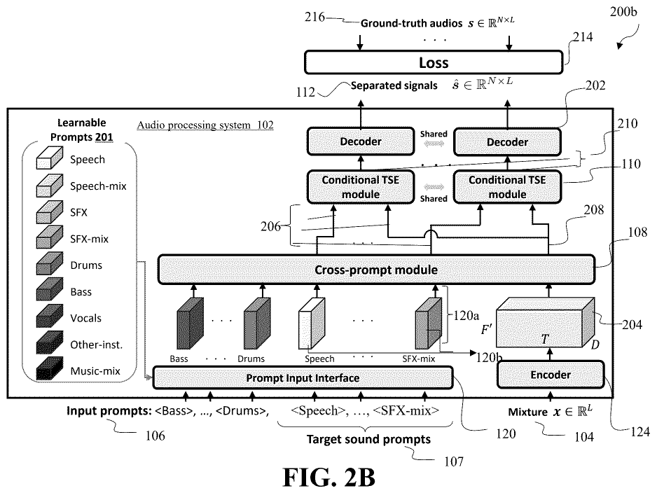

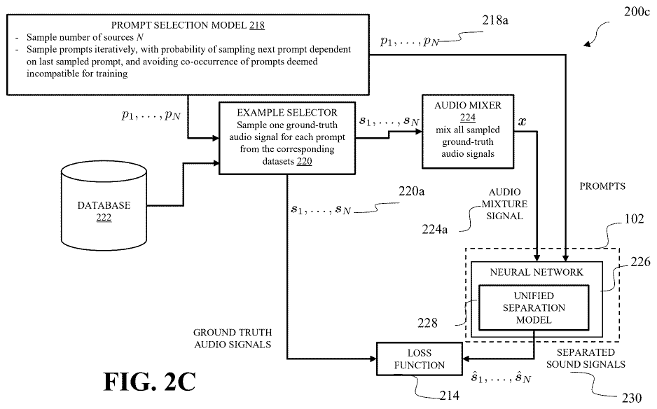

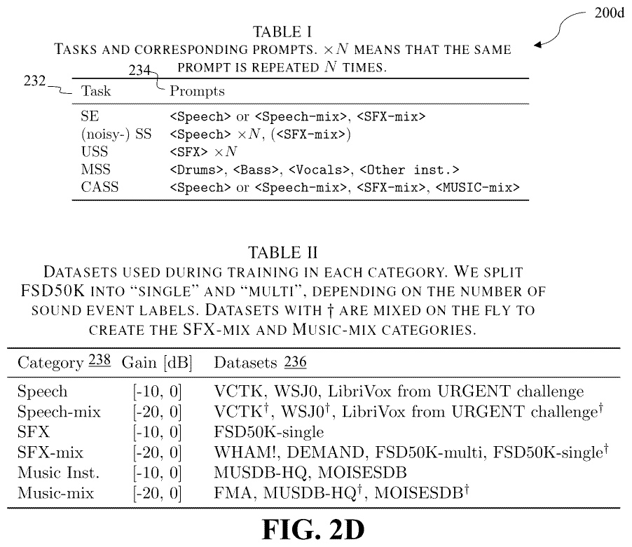

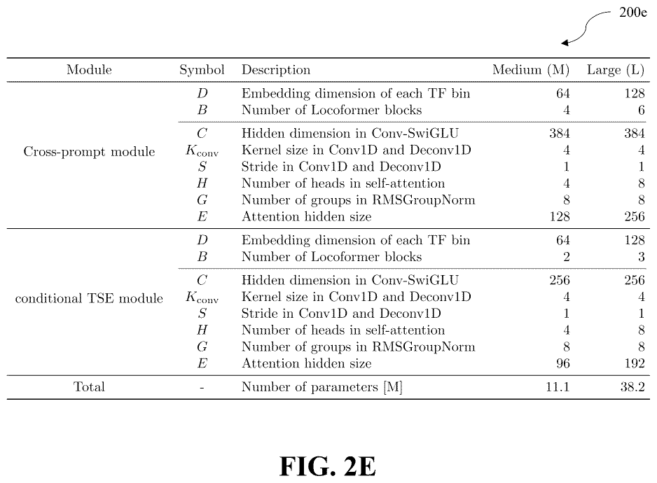

In an embodiment, the modules of the audio processing system 102 include the information exchanger neural network 108, that comprises an attention mechanism such that the information exchanger is trained to place each of the target sound prompts 107 in attention to each of the input digital encodings of the input sound prompts 106 and the audio mixture 104 to modify all of the target digital encodings of the target sound prompts 107 and the audio mixture 104. To that end, the information exchanger neural network 108 processes the features derived from the audio mixture 104 to place each of the target digital encodings in attention to each of the input digital encodings and the audio mixture 104. Details of the information exchanger neural network 108 are discussed further in conjunction with FIG. 2A.

In an embodiment, the modules of the audio processing system 102 include the extraction neural network 110, that is configured to process the features of the audio mixture 104 with a conditional target sound extraction (TSE) module conditioned separately or concurrently on each of the modified target digital encodings. Details of the extraction neural network 110 are discussed further in conjunction with FIG. 2A. In an embodiment, the conditional TSE module includes a neural network having a TF-Locoformer architecture.

In an embodiment, the conditional TSE module is executed multiple times for different modified target digital encodings to extract and output multiple sound sources.

In an embodiment, the audio processing system 102 is configured to combine embeddings of the target sound prompts 107 and the features derived from the audio mixture 104 to generate a combined feature, the combined feature applied to the information exchanger neural network 108. In some embodiments, the combining consists in replicating the embeddings of the target sound prompts 107 so that the dimensions of each replicated embedding corresponds to the dimension of a portion of the features derived from the audio mixture 104 corresponding to a single time frame. For example, each prompt (of dimension D) may be repeated F times so that a combined feature of size D×F′ (or equivalently D×1×F′) is generated, which corresponds to 1 frame of the features derived from the audio mixture 104. Thus, the combined feature may be a tensor of dimension D×(N+T)×F′.

In an embodiment, the information exchanger neural network 108 comprises a self-attention module.

In an embodiment, the audio processing system 102 includes the prompt input interface 120 that is configured to accept one or more prompts as input and transform each of the one or more prompts into digital encodings, for example in the form of features or embeddings, that may be processed by the information exchanger neural network 108.

In an embodiment, the prompt input interface 120 transforms input prompts into input digital encodings which include numerical embeddings suitable for transformer-based models. In an embodiment, the prompt input interface 120 may be configured to further transform the input digital encodings by combining them with digital encodings corresponding to one or more tokens, such a beginning of sequence token, an end of sequence token, and the like.

In an embodiment, the prompt input interface 120 takes as input a speaker embedding obtained from another speaker embedding extraction module, such as i-vector, d-vector, or x-vector, and transforms the speaker embedding for input to the cross-prompt module. Transformation may include applying a neural network.

In an embodiment, the prompt input interface 120 takes as input a recording of a reference sound sample and extracts an embedding from that reference sound sample. The reference sound sample may include a speaker utterance, a natural sound or group of natural sounds, a music excerpt, an instrument, or any other sound. The prompt input interface 120 may process the reference sound sample to extract an embedding relevant to some characteristic of the speaker utterance, such as speaker embedding, emotion embedding, prosody embedding, or the like; to some characteristic of the natural sound or group of natural sounds, such as a type or class of the natural sound or group of natural sounds; to some characteristic of the music excerpt, such as a genre of the musical excerpt; to some characteristic of the instrument, such as a type or class of the instrument.

In an embodiment, the audio processing system 102 includes an encoder 124 configured to derive the features from the audio mixture 104. The encoder 124 is configured to extract features from the audio mixture 104 by transforming raw audio signals into a compact, high-dimensional representation that captures spectral, temporal, and structural characteristics. The encoder 124 may operate on waveform data or time-frequency representations, such as spectrograms, mel spectrograms, or cochleagrams, using signal processing techniques or machine learning models. In some embodiments, the encoder 124 may employ convolutional neural networks (CNNs), recurrent neural networks (RNNs), transformers, autoencoders, or self-supervised learning models to extract meaningful features, including but not limited to mel-frequency cepstral coefficients (MFCCs), spectral contrast, pitch contours, or timbral properties. The encoder 124 may further incorporate dimensionality reduction techniques to generate feature embeddings optimized for downstream tasks.

In some embodiments, the encoder 124 adaptively refines its feature representations based on training data, learned embeddings, or contextual metadata to enhance accuracy in classification, retrieval, or synthesis tasks.

In some embodiments, the encoder 124 is embodied as a part of the audio input interface 118.

In an embodiment, the audio mixture 104 is encoded into a time-frequency domain of a depth of a size of the input digital encoding, such that the information exchanger neural network 108 processes the encoding of the audio mixture 104.

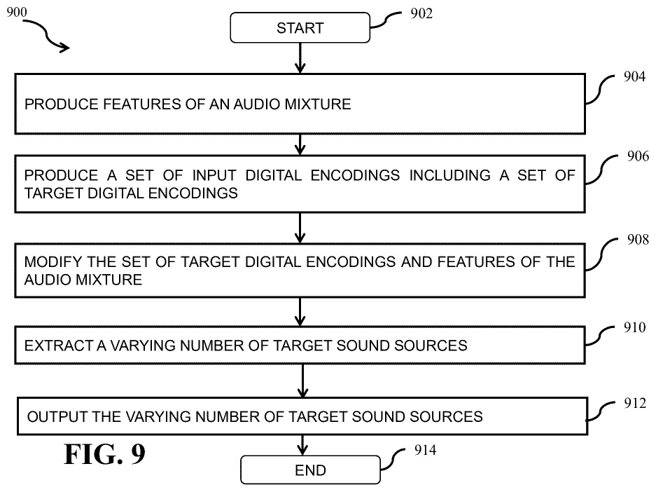

In an embodiment, the audio processing system 102 implements a method for processing the audio mixture 104. The method includes producing features of the audio mixture 104 formed by multiple sound sources. The method also includes producing the set of input digital encodings representing the input sound prompts 106 of at least some of the sound sources forming the audio mixture 104, in a space of the features of the audio mixture 104. The set of input digital encodings includes the set of target digital encodings representing target sound prompts 107 for extracting target sound sources from the audio mixture 104. The method includes modifying the target digital encodings and the features derived from the audio mixture 104 based on the input digital encodings and the features of the audio mixture 104. The method also includes extracting a varying number of the target sound sources by processing the modified target digital encodings and the modified features of the audio mixture 104 and further outputting the extracted target sound sources 112. The method is further described in detail in FIG. 9.

In an embodiment, the audio processing system 102 takes in as input the mixture of sound signals as the audio mixture 104 and multiple input prompts indicative of multiple sources or groups of sources present in the mixture, as both the input prompts 106 and the target prompts 107, process the input prompts 107 with the prompt input interface 120 to produce the set of input digital encodings of the input prompts 106, exchange information between the digital encodings and features of the audio mixture in exchanger 108, extracts the sound sources indicated by the target prompts by processing modified features of the audio mixture and modified digital encodings of the input and/or target prompts by the extraction network 110, and outputs, via the interface 122, as many separated signals as indicated by the target prompts.

FIG. 1C illustrates a block diagram 100c of a mode of operation of the audio processing system 102, according to an embodiment of the present disclosure. The block diagram 100c illustrates how the audio processing system 102 can take in as input a mixture of sound signals, also referred to as the audio mixture 104, and multiple input prompts, such as the input set of sound prompts 106 indicative of multiple sources or groups of sources present in the audio mixture 104, including a target set of sound prompts 107 designated as target sound prompts. In the mode of operation shown in FIG. 1C, the number of target sound prompts 107 is same as the number of input sound prompts 106. The audio processing system 102 is configured to output one or more separated signals, such as the separated sources 112, corresponding to the target sound prompts 107, wherein each separated signal corresponds to a target sound prompt.

FIG. 1D illustrates a block diagram 100d of another mode of operation of the audio processing system 102, according to an embodiment of the present disclosure. In the mode of operation shown in FIG. 1D, the number of target sound prompts 107 is strictly smaller than the input set of sound prompts 106, and the audio processing system 102 outputs one or more separated signals, such as the separated sources 112, corresponding to the target sound prompts, wherein each separated signal corresponds to a target sound prompt. In other words, the audio processing system 102 does not need to output signals for all prompts. For example, the block diagram 100d shows that the audio processing system 102 takes as input, N sound prompts as the input set of sound prompts 106, including a subset of two target sound prompts 107, and outputs as separated sources, only two separate sources, a separated source 1 and a separated source 2. Thus, in the mode of operation of the audio processing system 102 shown in FIG. 1D, the one or more separated signals corresponding to the separated sources 112 at the output correspond to a subset of the input prompts 106 formed by the target set of sound prompts 107, wherein each separated signal corresponds to a target sound prompt. The other input sound prompts are used to give context to the audio processing system 102, helping it separate the target sources by giving it indications about what other sources are present in the audio mixture 104.

FIG. 1E illustrates a block diagram 100e of another mode of operation of the audio processing system 102, according to an embodiment of the present disclosure. The mode of operation shown in the block diagram 100e corresponds to the classical “target source extraction” (TSE) setup, where there is a single sound prompt at the input and a single corresponding separate output. The input set of sound prompts 106 and the target set of sound prompts 107 are identical and have a single element, and the separated sources112 also have a single element. Thus, the audio processing system 102 is backward compatible with known or classical audio signal separation approaches, while also providing adaptability to adjust the output according to desired task. This is shown next in FIG. 1F.

FIG. 1F illustrates a block diagram 100f showing yet another mode of operation of the audio processing system 102, according to an embodiment of the present disclosure.

As illustrated in the block diagram 100f, the audio processing system 102 may change its behavior, including the number of outputs, based on the prompts, for the same input mixture. Two scenarios are shown in the block diagram 100f-a first scenario 100fl and a second scenario 100f2. In both cases, the input audio mixture consists of a mixture 126 of speech by two speakers, bass, and drums. In the first scenario 100f1, four input prompts are given as input-a first “<speech>” prompt 128a, a second “<speech” >prompt 128b, a “<bass>” prompt 128c, and a “<drums>” prompt 128d, and are indicated as target sound prompts 107. As a result of operation of the audio processing system 102, at the output, a bass signal 130d and a drums signal 130c are output as separate sources, along with two outputs for a speaker 1 signal 130a and a speaker 2 signal 130b.

In the second scenario 100f2, the same mixture of speech 126 is given as input, along with the first “<speech>” prompt 128a, the second “<speech>” prompt 128b, and a “<Music-mix>” prompt 132. The “<Music-mix>” prompt 132 indicates a mixture of musical instruments. All three input sound prompts are indicated as target sound prompts. After processing the inputs by the audio processing system 102, at the output, a mixture of the bass signal and the drums signal 134c is output as a single separated source, along with two separated sources for the speaker 1 signal 134a and the speaker 2 signal 134b.

Thus, the audio processing system 102 is able to perform adaptably and flexibly, adjusting the output based on the input and the desired task to be performed.

In some embodiments, the audio processing system 102 leverages the architecture of the information exchanger neural network 108 and the extraction neural network 110, and accepts learnable prompts at the input, to provide the flexible processing of the input. One such architecture of the audio processing system 102 and the information exchanger neural network 108 and the extraction neural network 110 is illustrated in FIG. 2A.

FIG. 2A illustrates a block diagram 200a of an architecture of operation of the audio processing system 102 and its various modules, according to various embodiments of the present disclosure. In these embodiments, the audio processing system 102 takes as input, the input set of prompts 106. The input set of prompts 106 are processed by the prompt input interface 120 to produce a corresponding set of input digital encodings 120a which further includes a set of target digital encodings 120b. The digital encodings of the input/target prompts are retrieved from a codebook of learnable prompts 201 based on designations 106 and 107 received by the prompt input interface, e.g., from a user. These learnable prompts 201 are initialized randomly and jointly trained with the audio processing system 102, in an embodiment. In the example shown in FIG. 2A, the input set of prompts 106 include multiple sound prompts corresponding to audio classes from a set of allowable audio classes-<Speech>, <Speech-mix>, <SFX>, <SFX-mix>, <Drums>, <Bass>, <Vocals>, <Other inst.>, and <Music-mix>. Out of the input set of sound prompts, a subset of sound prompts are selected and indicated as the target sound prompts 107, for example via a user interface. In this embodiment, the only difference between the target sound prompts 107 and other input sound prompts 106 that are not target sound prompts is that only modified target digital encodings 206 output by the cross-prompt module are processed with the modified features 208 derived from the audio mixture 104 by the conditional TSE module. That is to say, the input digital encodings 120a corresponding to all the input sound prompts 106 are passed to the information exchanger neural network 108. However, at the output of the information exchanger neural network 108, modified digital encodings corresponding to only the target digital encodings 120b are passed further to the extraction neural network 110.

In some embodiments, each of the sound prompts in the input set of sound prompts 106 may be selected as one of the target sound prompts 107.

The audio processing system 102 processes the input digital encodings 120a representing the input set of sound prompts 106 (or the input sound prompts 106) using the information exchanger neural network 108, which is a cross-prompt module. The information exchanger neural network 108 takes as input, the input digital encodings 120a and the target digital encodings 120b, which are a subset of the input digital encodings, and features 204 derived by the encoder 124 from the audio mixture 104. The information exchanger neural network 108 modifies the input digital encodings 120a, the target digital encodings 120b, and the features 204 derived from the audio mixture 104 by allowing information-sharing between all the input sound prompts 106 and the encoded features 204 of the audio mixture 104. Only the modified target digital encodings 206 corresponding to the target sound prompts 107 are output by the information exchanger neural network 108.

In some embodiments, the encoder 124 is configured to apply a short-time Fourier transform (STFT) to a time-domain waveform x∈ [symbol] (L is the number of samples) corresponding to the audio mixture 104. The result is a time-frequency (TF-) domain representation X∈ [symbol] , where T is the number of frames, F that of frequency bins, and 2 corresponds to real and imaginary parts. X is further transformed using learnable layers resulting in a 3-d tensor Z∈ [symbol] , referred to as mixture encoding or feature derived from the mixture. In some embodiments, the encoder 124 uses a band-split encoder that splits the TF-domain representation X with F frequency bins into K subband spectrograms Xₖ (k=1, . . . , K) with pre-defined bandwidths bₖ satisfying Σₖ bₖ=F. The real and imaginary parts of each subband spectrogram are concatenated and processed with a normalization layer and a linear layer, resulting in a feature Zₖ ∈ [symbol] . The K features are then concatenated and result in the mixture encoding 204 Z∈ [symbol] with shape D×T×F′ with F′=K, which is processed by the information exchanger neural network 108. In some embodiments, the encoder 124 uses a linear layer followed by a normalization layer to output the mixture encoding 204 Z∈ [symbol] , which is processed by the information exchanger neural network 108. For example, the linear layer may be a convolutional layer such as a Conv2D layer, and the normalization layer may be a global layer normalization layer, and the mixture encoding 204 Z∈ [symbol] is such that F′=F, the same number of frequency bins as the TF-domain representation X.

In some embodiments, the sub bands of the band-split encoder are determined by aggregating neighboring frequency bands together. The number of frequency bins to be aggregated into a single band is defined as follows: for instance, between 0 Hz and 1000 Hz, bins are grouped 2 by 2 to make a single band; between 1000 Hz and 2000 Hz, bins are grouped 4 by 4 to make a single band; similarly, groups of 12 bins are used for bands between 2000 Hz and 4000 Hz, groups of 24 bins are used for bands between 4000 Hz and 8000 Hz, and groups of 48 bins are used for bands between 8000 Hz and 16 kHz. Band-splitting with this configuration results in 57 bands between 0 Hz and 16 kHz when the sample rate is 48 kHz (rounding to the nearest numbers to determine the exact number of bands from each frequency range). Additionally, frequency bins above 16 kHz are split into 4 subsets with equal numbers of bins, resulting in 57+4=61 bands in total.

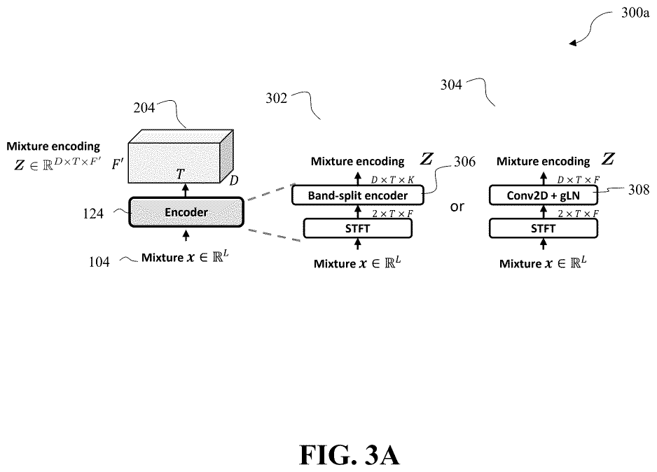

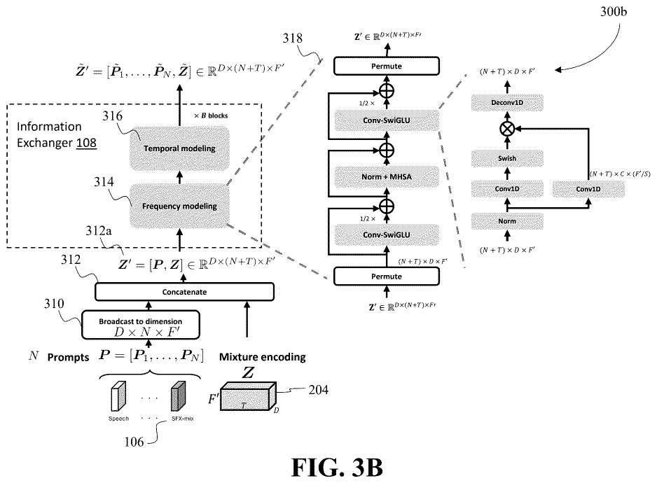

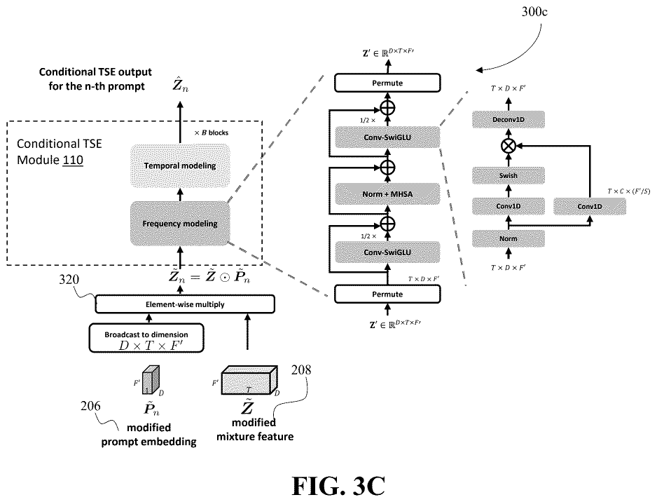

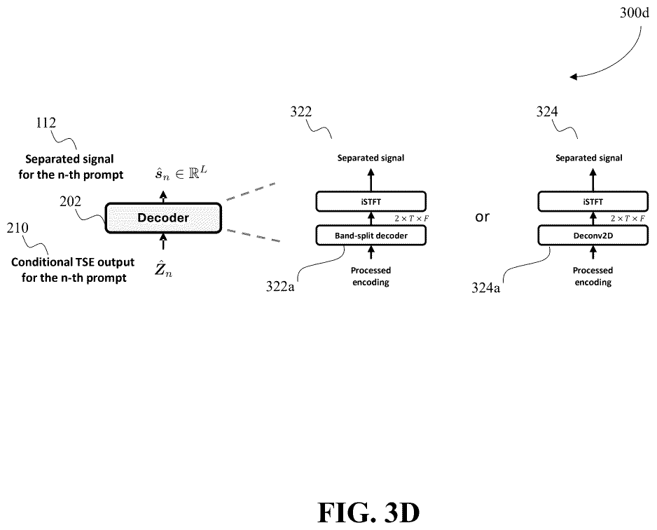

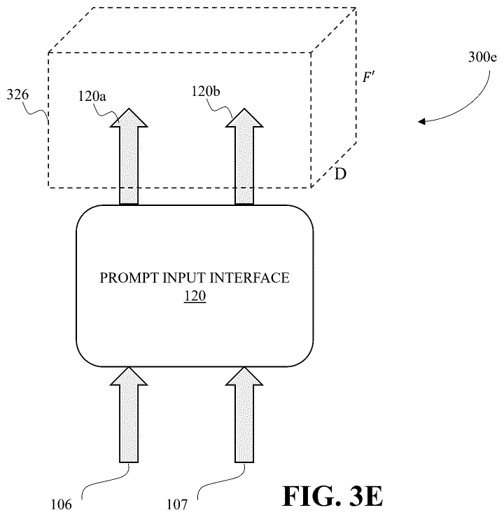

FIG. 3A illustrates a block diagram 300a showing details of the encoder 124, according to an embodiment of the present disclosure. In some embodiments, the encoder 124 may be implemented in either of the two architectures shown in FIG. 3A. In one embodiment, the encoder 124 is implemented as a band-split architecture 302. In one embodiment, the encoder 124 is implemented as a convolutional architecture 304.

In some embodiments, the encoder 124 comprises the first architecture 302. In the first architecture 302, the encoder 124 includes a band-split encoder 306. The band-split encoder 306 is configured to decompose the input audio mixture 104 into multiple frequency bands for feature extraction, analysis, or transformation. The band-split encoder 306 operates by applying a filtering process, such as learnable convolutional filters, wavelet transforms, or sub band decomposition techniques, to partition the audio mixture 104 into distinct spectral components. This decomposition allows for targeted processing of frequency-specific characteristics, improving the efficiency and accuracy of downstream tasks such as speech enhancement, source separation, noise reduction, or audio synthesis.

In some embodiments, the encoder comprises the second architecture 304. In the second architecture 304, the encoder comprises a Conv2D layer and a global layer normalization (gLN) layer 308. The Conv2D layer applies trainable convolutional filters to a two-dimensional input, such as spectrograms, images, or other structured data, to extract spatial and temporal features. The global layer normalization (gLN) component normalizes activations across all feature channels, rather than per-channel or per-instance normalization, ensuring consistency in feature scaling and improving training stability.

Referring back to FIG. 2A, the audio processing system 102 further includes the information exchanger neural network 108. In some embodiments, the information exchanger neural network 108 includes an attention mechanism such that the information exchanger neural network 108 is trained to place each of the input sound prompts 106 and the features 204 derived from the audio mixture 104 in attention to each of the input sound prompts 106 and the features 204 derived from the audio mixture 104 to modify all of the input sound prompts 106 and the features 204 derived from the audio mixture 104. That is to say, the prompt embeddings 111a of the input sound prompts 106 are processed with the features derived from the audio mixture 104. To that end, the information exchanger neural network 108 is based on a transformer architecture, which includes self-attention based processing of the input sound prompts 106 and the features 204 derived from the audio mixture 104.

The information exchanger neural network 108 is configured to achieve two objectives—first, N learnable prompts Pₙ, each with shape D×1×1, that is the prompt embeddings corresponding to the input sound prompts 106 and retrieved from a learnable codebook of prompt embeddings, are first stacked F′ times along the frequency dimension (each resulting in a tensor of size D×1×F′) and then concatenated at the front of the encoded feature 204, Z, along the temporal dimension, resulting in a tensor Z′=[P, Z]∈ [symbol] Z′ is then input to Transformer-based blocks of the information exchanger neural network 108, to model the dependency of the temporal sequence. This process not only enables the mixture 104 to be modeled conditioned by the input sound prompts 106, that is the input digital encodings 120a but also allows each input sound prompt of the input sound prompts 106 to be processed conditioned on the audio mixture 104 and the other of the input sound prompts 106. This helps in conditional separation that happens in the extraction neural network 110 in subsequent modules.

Further, because of application of convolutions, and optionally positional encoding, and self-attention by the transformer-based blocks of the information exchanger neural network 108, even identical prompts at different positions result in different values. In addition, the Transformer-based architecture by design accepts sequences with arbitrary length, which enables the audio processing system 102 to receive any number of prompts as the input sound prompts 106. As a result of this processing, the digital encodings of the input sound prompts 106 and the features 204 are modified by the information exchanger to provide modified digital encodings of the target sound prompts 206 and modified features 208 from the audio mixture 104. The modified target digital encodings 206 and the modified features 208 from the audio mixture 104 are then passed to the extraction neural network 110 for further processing. An example architecture of the information exchanger neural network 108 is shown in FIG. 3B.

FIG. 3B illustrates a block diagram 300b showing details of the information exchanger neural network 108 or cross-prompt module, which is based on a TF-Locoformer architecture. A TF-Locoformer (time-frequency domain Transformer with local modeling by convolution) is a specialized deep learning model designed for audio signal processing, particularly for source separation, speech enhancement, and music decomposition. It improves upon traditional Transformer-based models for time-frequency domain modeling of an audio signal by applying feedforward networks with convolutional layers instead of simple linear layers for local modeling, letting the self-attention layers focus on modeling global patterns.

The digital encodings 120a of the input sound prompts 106 are first broadcast to dimension D×N×F′ 310 as described above, by replicating them F′ times along the frequency dimensions and concatenating them, leading to a prompt embedding tensor P∈ [symbol] , and then the prompt embedding tensor P of the input digital encodings 120a is concatenated 312 with the encoded mixture or the features 204 derived from the audio mixture 104 to generate a concatenated feature vector 312a Z′=[P, Z]. The concatenated feature vector 312a is then applied to the information exchanger neural network 108, where it iteratively goes through B frequency-and-temporal processing blocks, where in each block it undergoes frequency modeling 314 and temporal modeling 316. Both the frequency modeling 314 and the temporal modeling 316 include a similar architecture which only differs by the way the concatenated feature vector Z′ is permuted at the input and output of the architecture. By way of example, only the details of the frequency modeling architecture 318 are described in FIG. 3B. Frequency modeling architecture 318 includes multiple permute, Conv-SwiGLU, and Norm+MHA modules. We permute the dimension order of Z′ to (N+T)×D×F′, then apply a ConvSwiGLU module, a normalization layer Norm, which will be described later, a multi-head self-attention layer MHSA, and another ConvSwiGLU module as follows:

$${Z}^{′} ← {Z}^{′} + ConvSwi GLU ( {Z}^{′} )$$

$${Z}^{′} ← {Z}^{′} + MHSA ( Norm ( {Z}^{′} ) )$$

$${Z}^{′} ← {Z}^{′} + ConvSwi GLU ( {Z}^{′} )$$

MHSA has H heads, and each head processes D/H-dimensional features. We use rotary positional encoding for encoding the relative position of each frequency bin. After the second ConvSwiGLU, Z′ is permuted back to their original shape of D×(N+T)×F′ for subsequent processing.

The temporal modeling architecture only differs from the frequency modeling architecture 318 in the Permute blocks, and accordingly the dimensions of the various layers. The feature Z′ is permuted so that its dimension becomes F′×D×(N+T), then goes through similar Conv-SwiGLU and Norm+MHA modules and is eventually permuted back to D×(N+T)×F′.

The ConvSwiGLU modules are feedforward networks which boost the local-modeling capability by utilizing 1d-convolution and 1d-deconvolution layers instead of linear layers. Each ConvSwiGLU module performs the following sequence of computations on a 3-dimensional tensor Z:

$$Z ← Norm ( Z )$$

$$Z ← Swish ( Conv 1 D ( Z ) ) ⊗ Conv 1 D ( Z )$$

$$Z ← Deconv 1 D ( Z )$$

Where Swish denotes the Swish activation, ⊗indicates element-wise product, and the two Conv1D layers are different from each other, and all Conv1D and Deconv1D layers have stride S.

Each Norm normalization layer may be one of a layer normalization layer, a root mean square normalization (RMSNorm) layer, and a root mean square group normalization (RMSGroupNorm) layer. In an RMSGroupNorm layer, we view each D-dimensional vector [symbol] as a stack of G vectors of dimension D/G, where G is the group size, and we normalize each D/G-dimensional vector separately. This encourages the model to disentangle each D-dimensional vector into different groups, which may be helpful for speech separation. We normalize each TF bin, unlike the group normalization in image processing. As in RMSNorm, RMSGroupNorm features an affine transform with two D-dimensional learnable parameters. G=1 corresponds to the original RMSNorm.

The output generated by the information exchanger neural network 108 is fed to the extraction neural network 110.

Referring back to FIG. 2A, the extraction neural network 110 is trained to extract a varying number of target sound sources, also referred to as the separated signals 112, corresponding to the target digital encodings and/or target prompts by processing the modified target digital encodings 206 and the modified features 208 derived from the audio mixture 104.

In one embodiment, the extraction neural network 110 includes a conditional target sound extraction (TSE) module which processes the modified digital encodings of the target sound prompts 206 and the modified features 208 derived from the audio mixture 104.

The conditional TSE module is configured to isolate a target sound from an audio mixture using an auxiliary conditioning input. The conditioning input may include a reference signal, such as a speech sample, instrument clip, or predefined feature embedding, to guide the extraction process. The conditional TSE module processes both the audio mixture and the conditioning input using feature extraction techniques, such as convolutional layers, recurrent networks, or transformer-based encoders. A conditioning mechanism, which may include attention-based fusion, feature concatenation, or adaptive modulation, is applied to refine the extracted sound while suppressing non-target sources. The conditioning mechanism may also include multiplying the input features with the auxiliary conditioning input elementwise, adequately broadcasting the auxiliary conditioning input to match the dimensions of the input features. The conditioning of the conditioning TSE module may be done either separately or concurrently on each of the modified target digital encodings 206. The conditional TSE module in the extraction neural network 110 is shared across different iterations of processing of the modified target digital encodings 206 and the modified features 208 of the audio mixture 104. Thus, the conditional TSE module of the extraction neural network 110 is executed multiple times for different modified target digital encodings 206 to extract and output multiple sound sources.

In some embodiments, the conditional TSE module in the extraction neural network 110 extracts the source specified by each modified target sound prompt 206 in parallel. An example architecture of the extraction neural network 110 is shown in a block diagram 300c in FIG. 3C, according to an embodiment of the present disclosure.

In one embodiment, the conditional TSE module 110 also follows a TF-Locoformer architecture similar to FIG. 3B. The output \tilde{Z}′ of the information exchanger neural network 108 is first split into the features \tilde{P} corresponding to all modified input digital encodings, from which the features \tilde{P}ₙ corresponding to each modified target sound prompt 206 is further extracted, and the modified feature 208, \tilde{Z} corresponding to the mixture 104. n is an index for the target sound prompts. Then each prompt \tilde{P}ₙ is first broadcasted to the dimension D×T×F′ of \tilde{Z} via replication and then multiplied elementwise 320 by Z, resulting in a feature conditioned by a prompt \tilde{Z}n=\tilde{Z}⊙\tilde{P}ₙ, where ⊙ indicates multiplication elementwise with appropriate broadcasting. Each Zn is further processed by several learnable layers of the extraction neural network 110 (also referred to equivalently as the conditional TSE module 110), which are shared for all n.

Referring back to FIG. 2A, further, a decoder 202 of the audio processing system 102 then receives each output 210 \tilde{Z}n of the extraction neural network 110, as input, and converts it back to the time-domain waveform using an MLP block and inverse STFT, resulting in separated signals 112 ŝ∈ [symbol] Example architectures of the decoder 202 is illustrated in a block diagram 300d in FIG. 3D, according to embodiments of the present disclosure.

FIG. 3D shows a block diagram 300d showing details of different architectures of the decoder 202, according to an embodiment of the present disclosure. The decoder 202 may include a band-split architecture 322 or a convolutional architecture 324.

The band-split architecture 322 includes a band-split decoder 322a. In this setting, which is used in association with the band-split encoder 302, F′=K. The band-split decoder 322a is configured to reconstruct an audio signal from multiple frequency sub bands that have been separately processed or encoded. The band-split decoder 322a receives an output 210 \hat{Z}ₙ ∈ [symbol] of the extraction neural network 110, and splits the features into a set of K band-specific feature representations \hat{Z}_{n,k} ∈ [symbol] which are each decoded by passing them through a layer normalization module followed by a multilayer perceptron (MLP) module with one hidden layer to generate the real and imaginary parts of a time-frequency mask M_{n,k} ∈ [symbol] , using the same pre-defined bandwidths by as during the encoding by the band-split encoder. As in the band-split encoder, each sub band feature has its own normalization module and MLP. All TF masks M_{n,k} are then concatenated into a full-band TF mask Mₙ ∈ [symbol] and multiplied with X∈ [symbol] to generate the separated source spectrogram Ŝₙ ∈ [symbol] . A time-domain separated source signal îₙ ∈ [symbol] can then be obtained by inverse STFT.

The second architecture 324 includes a Deconv2D layer 324a. The Deconv2D layer 324a (also referred to as a transposed convolutional layer or fractionally stride convolution) is a neural network component configured to up sample and reconstruct spatial feature maps in two-dimensional data, such as images or spectrograms. The Deconv2D layer 324a performs an inverse operation of a standard 2D convolution (Conv2D) by applying learnable filters to expand low-resolution feature representations into higher-resolution outputs while preserving learned spatial structures.

In some embodiments, the Deconv2D layer 324a reconstructs features by applying trainable kernels in a reversed convolutional manner, wherein each input value contributes to multiple output positions, enabling structured up sampling. The layer may be used in audio and image processing tasks, such as speech enhancement, source separation, super-resolution, and generative models. The Deconv2D layer 324a may further incorporate activation functions, normalization techniques, or attention mechanisms to refine the reconstruction process and enhance feature synthesis. The real and imaginary components of target sound source n can be obtained by applying a DeConv2D layer to the features Îₙ ∈ [symbol] , where in this case F′=F, to obtain the separated source spectrogram Ŝₙ ∈ [symbol] . A time-domain separated source signal îₙ ∈ [symbol] can then be obtained by inverse STFT.

The decoder 202 may implement any of the architectures illustrated in FIG. 3D. In various embodiments, the decoder 202 is also shared for all n. The separated signals 112 provided by the decoder 202 may be outputted through the output interface 122 (shown in FIG. 1B) and may be further used to perform a task. In an embodiment, the task may include receiving the audio mixture 104 at the audio input interface 18, and receiving the input sound prompts 106 at the prompt input interface 120 and extracting multiple sound sources. The prompt input interface 120 is described in FIG. 3E.

FIG. 3E illustrates a block diagram showing details of the prompt input interface 120, according to an embodiment of the present disclosure. The prompt input interface 120 receives at its input, the input sound prompts 106, including the target sound prompts 107. The prompt input interface 120b transforms the input sound prompts 106 into the input digital encodings 120a and the target sound prompts 107 into the target digital encodings 120b. This transformation is done in a feature space 326 equivalent to the feature space of the features of the audio mixture 104.

In various embodiments, the different modules of the audio processing system 102, such as the information exchanger neural network 108, the extraction neural network 110, and the decoder 202 may be trained to minimize a loss in such a manner that the separated signals 112 are accurately distinguishable, as per the underlying task. The training of the different modules of the audio processing system 102 and of the overall audio processing system 102 itself is described in the following figures.

FIG. 2B illustrates a block diagram 200a showing training of the audio processing system 102, according to an embodiment of the present disclosure. The FIG. 2B is explained in conjunction with FIG. 2A. The audio processing system 102 may be configured to perform all of the operations described in FIG. 2A, with an objective of minimizing a loss 214. The loss 214 is computed on the basis of ground truth audio signals 216, s∈R^{N×L} and the separated signals 112, ŝ∈R^{N×L.}

In an embodiment, when the loss 214 is computed, although the order of the separated signals 112 may be the same as that of the target sound prompts 107, the order of sources in the audio mixture 104 may not be known, when multiple prompts from the same category are used. Therefore, the loss 214 is computed as a permutation-invariant (PIT) loss for each category independently and loss of each category is averaged to compute the overall loss 214. For example, if there are multiple target sound prompts specified as <Speech>, each corresponding separated source signal is expected to correspond to a speech signal which should be matched with one of the reference speech signals, but it cannot be determined which one it should be without further comparing the separated signals and the reference signals. In such a case, all possible permutations of reference source signals of the Speech category are considered when matching the set of Speech reference signals with the set of Speech separated signals and the permutation that corresponds to the smallest loss for backpropagation is selected. This permutation-invariant determination of the loss is done independently for each source category.

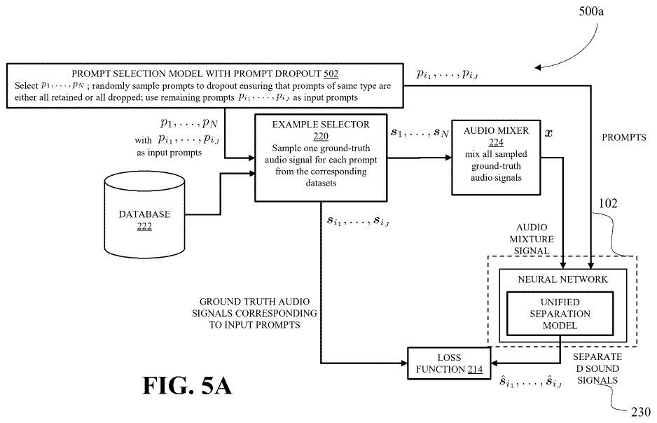

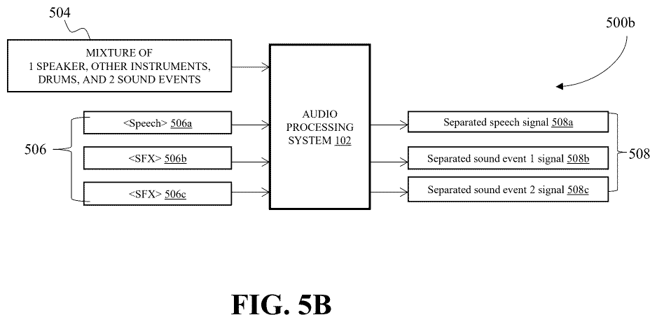

FIG. 2C illustrates a block diagram 200c showing further details for training of the audio processing system 102, according to an embodiment of the present disclosure. FIG. 2C illustrates training in the particular case where all input sound prompts 106 are target sound prompts 107. A case where some input sound prompts 106 are not included in the target sound prompts 107 is illustrated in FIG. 5A.

During training, a prompt selection model 218 is used to select input sound prompts 218a for training. For example, the prompt selection model 218 selects prompts 218a from a predetermined set of allowed sound prompts for training the audio processing system 102. To prepare a training sample, a number N of sources is randomly selected between certain values (e.g., between 1 and 4) with some probability, then N prompts 218a are randomly selected following certain rules. Given the selected prompts 218a, N audio samples 220a are randomly sampled by an example selector 220 from datasets determined by the type of each prompt in the input sound prompts 218a. The N audio samples 220a are ground truth audio signals that are randomly selected by the example selector 220 from the datasets stored in a database 222. In some embodiments, the rules for randomly selecting the prompts 218a are such that a first prompt is selected based on a prior probability of first selecting each prompt, and all subsequent prompts are sampled following a conditional probability dependent on the last sampled prompt, avoiding co-occurrence of prompted deemed incompatible for training, until N prompts have been selected. A type of an audio sample to select is determined based on the type of input prompt.

The sampled audio samples 220a are used by an audio mixer 224 to create a mixture 224a used as input to the audio processing system 102. The sampled prompts 218a are also given as input to the audio processing system 102. Based on the input mixture 224a and the prompts 218a, the audio processing system 102 outputs N separated sound signals 230, which are used, together with the N sampled audio signals 220a used as ground-truth audio signals to compute the loss 214 function for training.

In an embodiment, the audio processing system 102 includes a neural network 226, which further includes a unified separation model 228 that is configured to provide the separated sound signals 230 based on the input mixture 224a, the sampled prompts 218a, the ground truth audio signals 220a, and the loss 214 function. To that end, the unified separation model 228 includes the modules—the information exchanger neural network 108, the extraction neural network 110, the encoder 124, and the decoder 202 shown earlier in FIG. 2A and FIG. 2B. The training is done with the objective of minimizing the loss 214 function based on the ground truth data.

In various embodiments, repetition of multiple prompts 218a of the same category is performed, for example “<speech>,<speech>”. Further, the part of the loss 214 function that is computed on the outputs of the audio processing system 102 and the ground-truth signals 220a corresponding to these repeated prompts is computed using permutation-invariant training, meaning that all permutations of the ground-truth signals 220a are allowed when comparing them with the output separated sound signals 230. Subsequently, the permutation leading to the smallest loss 214 is selected, and that permutation is used to compute the loss 214 function. Separated sound signals 230 and ground-truth signals 220a corresponding to prompts 218a that are not repeated are directly compared which each other (there is no need for finding a permutation as there is a straightforward match).

In various embodiments, during training, the audio mixture 224a is created on the fly. The datasets stored in the database 222 for training may be selected from known audio datasets, which are discussed further in FIG. 2D.

FIG. 2D illustrates a block diagram 200d showing lists of various tasks and corresponding prompts considered during training, as well as the associated datasets for each prompt category from which audio samples are sampled, according to an embodiment of the present disclosure.

The block diagram 200d includes Table I and Table II.

Table I illustrates a list of tasks 232 and their corresponding prompts 234, that are used for training the audio processing system 102. The tasks 232 include all of the major source separation tasks such as speech enhancement (SE), speech separation (SS), universal sound separation (USS), music source separation (MSS), and cinematic audio source separation (CASS). Since some tasks have contradictory goals, the audio processing system 102 is configured to change its behavior, including the number of output sources, depending on the input prompts. To this end, the audio processing system 102 is controlled by several prompts, such as the input set of prompts 106 or the prompts 218a to specify what source to separate and optionally what other sources are present in the audio mixture, as shown in FIG. 2A. As already discussed, sound sources are slit into the following 9 categories and the corresponding prompts are prepared: <Speech>, <Speech-mix>, <SFX>, <SFX-mix>, <Drums>, <Bass>, <Vocals>, <Other inst.>, and <Music-mix>. The <*-mix>prompts are for grouping all the sources from that category, while the others are for extracting individual sources. As shown in Table I, the five typical tasks mentioned earlier can be covered by changing the combination of the prompts. The audio processing system 102 also accepts other arbitrary combinations of prompts, except for the combinations including both <Speech-mix> and <Speech>, both <SFX-mix> and <SFX>, and <MUSIC-mix> and individual instruments. More prompts may also be added in the future to manage a greater variety of tasks, without deviating from the scope of the present disclosure. In some embodiments, a<Speech-mix>prompt for extracting speech mixtures may also be included in the set of learnable prompts.

To address all five tasks in Table I, the audio processing system 102 is configured to accept a variable number of prompts, since each task has a different number of outputs. The audio processing system 102 is also configured to accept multiple identical prompts (e.g., N-speaker speech separation is specified via N <Speech>prompts, all identical, and the audio processing system 102 has to output N different speech signals). Specifically, the Transformer-based architecture of the audio processing system 102 enables the audio processing system 102 to flexibly adapt to any type of audio processing task, even contradictory ones. This provides a cost effective and computationally efficient solution for audio processing tasks, as several different models need not be trained and implemented for each type of task. This also allows the single model to be trained on many different datasets, thus increasing the performance of the model, and allowing the training of larger models.

The audio processing system 102 uses the datasets 236 shown in table II for training according to different categories 238 of tasks. The datasets 236 include, for example, LibriVox data from the URGENT challenge for creating <Speech>sources, or for creating <Speech-mix>sources by mixing multiple samples. DNSMOS-based filtering may be used to remove noisy speech samples. Another dataset is FSD50K, which may be used to create <SFX>sources, or for creating <SFX-mix>sources by mixing multiple samples. To avoid ambiguity with <Speech> and music related sources, samples from FSD50k corresponding to human speech and musical instruments are filtered out. The samples can be split into two groups, “single” and “multi,” depending on the number of leaf sound-class labels and the audio length. “Single” includes audio with a single sound-class label and shorter than 8 s, while “multi” includes those with multiple labels or longer than 8 s. “Single” samples are used to create <SFX>samples, while “multi” samples are used to create <SFX-mix>samples.

In some embodiments, the datasets 236 are used to randomly sample an audio file from the corresponding category.

As shown in Table II, for SFX-mix and Music-mix tasks, multiple sources from SFX or Music Inst. may be mixed in advance or on the fly, instead of using FSD50K or FMA. Since sources from different datasets can have different sampling rates, the sources may be re-sampled to the lowest sampling rate among selected sources, then up sampled to 48 kHz. Finally, sources are RMS-normalized, scaled by gains uniformly sampled from the ranges shown in Table II, and mixed to create a mixture.

In various embodiments, the evaluation partition of five datasets may be used to evaluate the audio processing system 102 on multiple separation tasks. VCTK-DEMAND is used for the SE task. It includes noisy speech mixtures derived from VCTK speech and DEMAND noise sampled at 48 KHz. WHAM! (max version) is used for the noisy SS task. Speech and noise are from the WSJ and WHAM! corpora, respectively, sampled at 16 kHz. FUSS is used for the USS task. Two to four sources from the FSD50K corpus sampled at 16 kHz are mixed. MUSDB-HQ is used for the MSS task, where the goal is to separate mixtures into vocals, bass, drums, and other instruments. The sampling rate is 44.1 kHz. DnR is used for the CASS task. Speech, Music-mix, and SFX-mix sources are obtained from LibriSpeech, free music archive (FMA), and FSD50K, respectively, sampled at 44.1 kHz.

Thus, using the various datasets 236 the audio processing system 102 may be trained to perform different tasks.

FIG. 2E illustrates a table 200e showing some hyperparameters notations and definitions for training the audio processing system, according to an embodiment of the present disclosure.

In some embodiments, the hyperparameters for training the audio processing system 102 are defined for two configurations-a large model and a medium model. For the medium model, the hyperparameters include number of Locoformer blocks B=4, embedding dimension of each TF bin D=64, hidden dimension in Conv-SwiGLU C=384, kernel size in Conv1D and Deconv1D Kconv=4, stride in ConvID and DeconvID S=1, number of heads in self-attention H=4, number of groups in RMSGroupNorm G=8, and attention hidden size E of 128 in the cross-prompt module or the information exchanger neural network 108. In the conditional TSE module of the extraction neural network 110 for the Medium model, the hyperparameters are defined as B=2, C=256, and E=96 with other settings unchanged from the cross-prompt module. For the Large model, the hyperparameters are defined as B=6, D=128, C=384, K=4, S=1, E =256 H=8, and G=8 in the cross-prompt module, and B=3, C=256, and E=192 with other settings unchanged in the conditional TSE module. The medium and large models have 11.1M and 38.2M parameters, respectively. Note that a linear layer may be used instead of a convolution layer for the temporal modeling in the cross-prompt module, while a convolution layer may be used in the conditional TSE module.

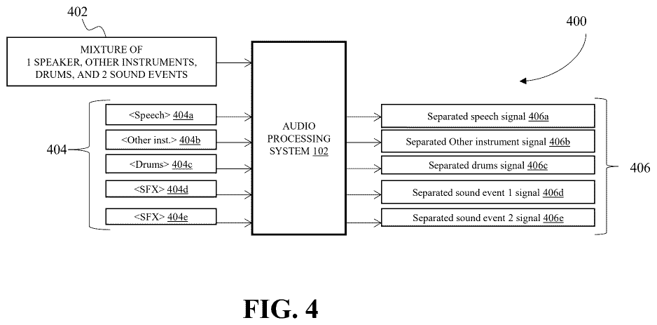

In some embodiments, the audio processing system 102 may also be configured to receive as input, sound prompts that the audio processing system 102 has never seen during training. The audio processing system 102 is still able to perform any underlying task with accuracy. This is discussed in conjunction with FIG. 4.

FIG. 4 illustrates a block diagram 400 of the audio processing system 102 that can use combinations of prompts never seen during training, according to an embodiment of the present disclosure. FIG. 4 is explained in conjucntion with all of the preceding figures described above.

In the example shown in FIG. 4, the audio processing system 102 can manage 5 prompts or more at test time even though it was trained with 4 prompts. In the example of FIG. 4, the input audio mixture 402 is a mixture of speech by one speaker, “other” instruments (which are not vocals, bass, or drums), drums, and two different sound events. The example sound prompts 404 are “<Speech>” 404a, “<Other inst.>” 404b, “<Drums>” 404c, “<SFX>” 404d, “<SFX>” 404e. This combination of 5 prompts was never seen during training, which was limited to at most 4 sources in this example. However, the audio processing system 102 is still able to provide at output 406 separated sources corresponding to speech signal 406a, other instruments signal 406b, drum signal 406c, sound event 1 signal 406d, and sound event 2 signal 406e.

In an embodiment, the audio processing system 102 may be trained with prompt dropout, this is illustrated in FIG. 5A. In this training regime, the set of input prompts only corresponds to a strict subset of the sources in the audio mixture. In other words, some of the sources in the audio mixture are not specified in the input sound prompts, and the system does not have access to the complete information regarding the types of sources present in the mixture. This allows the system to still perform well at inference time even when a user does not exhaustively specify all the sources in the audio mixture.

FIG. 5A illustrates a block diagram 500a showing prompt dropout training of the audio processing system 102, according to an embodiment of the present disclosure. FIG. 5A is explained in conjunction with FIG. 2C. All the blocks and their functionality as shown in FIG. 5A are similar to FIG. 2C, except that during prompt dropout training, a prompt selection model with prompt dropout 502 is used instead of the prompt selection model 218. In order to make the audio processing system 102 more robust to cases where the user does not list prompts for all the sources in a mixture, leaving some sources unspecified, the audio processing system 102 may be trained or fine-tuned with “prompt dropout,”. To this end, the prompt selection model with prompt dropout 502 module is configured to use as sound prompts, only a subset of the prompts from which the sources in a mixture were selected. If some prompts are repeated, e.g., <speech>,<speech>, they are either all dropped or all kept.

In some embodiments, the prompt dropout training shown in FIG. 5A is used to train the audio processing system 102 in advance, which then later allows a user to specify only a subset of the sources. Thus, if there are total T sources in the input audio mixture 224a, U prompts (U<T) are removed and the audio processing system 102 tries to separate only T-U sources during training. In some embodiments, in 25% of the training steps, U prompts from [1, T) are sampled and U prompts are removed randomly. Here, when the prompts include multiple prompts from the same category, they are not removed because then the audio processing system 102 would have no objective way to know which of the sources from that category to separate.

FIG. 5B illustrates a block diagram 500b showing how the audio processing system 102 can be used to extract only a subset of the sources or groups of sources present in a mixture, according to an embodiment of the present disclosure.

In the example of FIG. 5B, the input to the audio processing system 102 is a mixture 504 of speech by one speaker, drums, other instruments, and two sound events. However, only three prompts 506 are provided as input—for speech 506a, SFX 506b and SFX 506c. The audio processing system 102 does not need to specify prompts for all sources in the mixture 504, here, three out of five sources are extracted at the output 506-a separated speech signal 508a, a separated sound event 1 508b, and a separated sound event 2 508c. Because the system has been training using prompt dropout, it has seen similar cases during training where only a subset of the sources in the audio mixture is specified as input prompts.

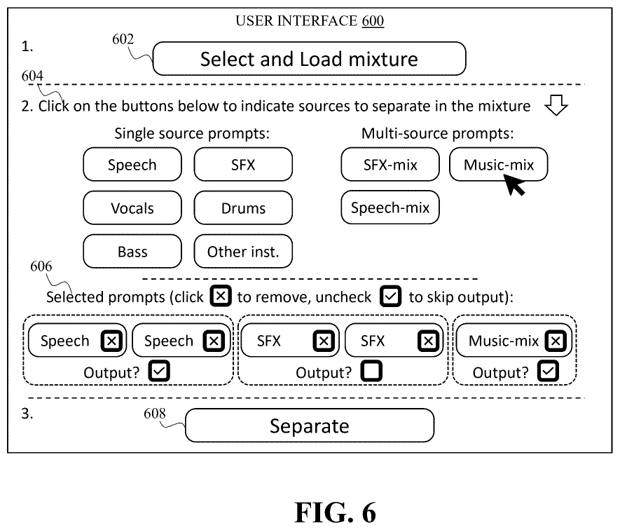

The audio processing system 102 may be associated with a user interface for interacting with a user to let them perform their desired task. This shown in FIG. 6.

FIG. 6 illustrates an example user interface 600 through which a user may interact with the audio processing system 102, according to an embodiment of the present disclosure. The user interface 600 may be a part of the prompt input interface 120. The user interface 600 includes a plurality of display options. A first option is provided by a first UI element 602, where a user can first select and load a mixture audio signal. A second option is a second UI element 604 that allows the user to select prompts corresponding to the desired sources to separate. The second UI element 604 displays a plurality of prompts that can be selected by the user such as speech, SFX, vocals, and the like. These displayed prompts correspond to the set of possible sound prompts from which the sound prompts in the input set of sound prompts 106 discussed earlier can be selected. Out of these, the user may then select a variable number of sound prompts that are present in the loaded audio mixture 104. A same prompt such as Speech or SFX may be selected multiple times if multiple sources of that type are deemed to be present in the audio mixture by the user. The prompts which user selects are displayed by a third UI element 606 and are considered as input sound prompts and form the set of input sound prompts 106. The user may further select which of the corresponding sources to output by checking a box next to the corresponding sound prompts in the third UI element 606. The prompts selected for source output are considered as target sound prompts and form the target set of sound prompts 107. Further, when the user clicks on a fourth UI element 608, the audio processing system 102 is triggered at the backend, and the process and/or method of separating the sources is executed, with the audio mixture and the set of input sound prompts and the set of target sound prompts as input.

In some embodiments, the audio processing system 102 may be configured to perform diverse tasks. Some of these are discussed in the following figures.

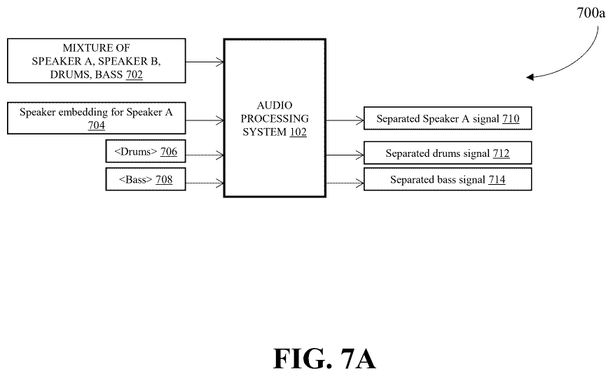

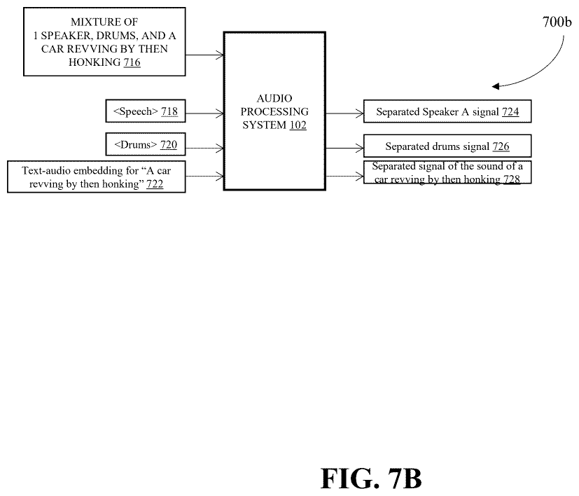

FIG. 7A illustrates a schematic 700a showing how the audio processing system 102 can be expanded to use other types of prompts beyond tokens indicating sound categories, according to an embodiment of the present disclosure. For example, the audio processing system 102 receives a mixture 702 of two speakers, drums, and bass. The audio processing system 102 also receives a speaker embedding 704 for Speaker A extracted from a reference utterance, such as x-vector, i-vector, or d-vector, to extract the speech of a specific speaker, instead of the speech of any speaker if it were specified by the learnable prompt <Speech>. The audio processing system 102 can also be extended to include prompts indicating emotion, prosody, gender, pitch, accent, language, loudness, distance, and other characteristics, or corresponding vector embeddings. Similarly, for music, the audio processing system 102 can be extended to include prompts related to music genre, harmonicity, timbre, and other characteristics, or corresponding vector embeddings. In this example, the audio processing system 102 also receives prompts for drums 706 and bass 708. Further the audio processing system 102 is configured to output separated sources corresponding to speaker A signal 710, drums signal 712, and bass signals 714.

FIG. 7B illustrates how the audio processing system 102 can also use a joint text-audio embedding 722, according to an embodiment of the present disclosure. The joint text-audio embedding 722, such as a CLAP embedding obtained from a natural-language query, can be used to specify using natural language sound event, an instrument, a sound scene, or a piece of music, instead of using generic learnable prompts <SFX>, <Drums>, <Bass>, <SFX-mix>, <Music-mix>, and the like. In the figure, some of the prompts are token-based and another is natural-language-based. The audio processing system 102 receives the mixture 716 consisting of speech by one speaker, drums, and the sound of a car revving by then honking, and prompts for speech 718, drums 720, and a text audio embedding 722 for the natural language query “A car revving by then honking”. The audio processing system 102 provides the output, a separated speaker signal 724, a separated drums signal 726, and a separated signal of the sound of a car revving by then honking 728.

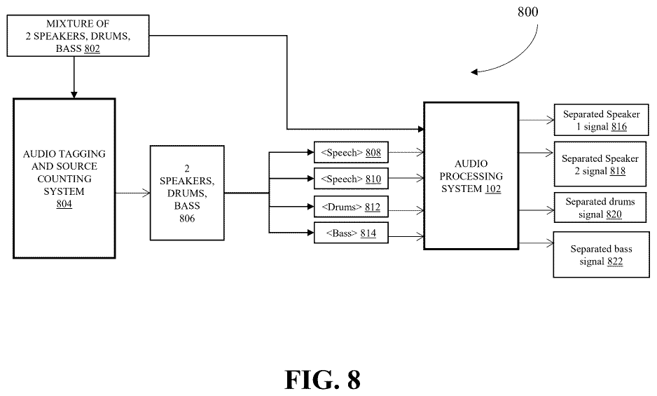

FIG. 8 illustrates a schematic 800 showing how the audio processing system 102 can be used as part of a system that fully separates a mixture signal without manual specification of the number and type of sources by a user, according to an embodiment of the present disclosure. An audio tagging and source counting system 804 processes the input audio mixture 802 to obtain a list of prompts 806 indicative of the sources identified in the mixture. The list of prompts, potentially including repeated prompts, is then used in combination with the input audio mixture 802 by the audio processing system 102 to separate the corresponding audio signals. As shown, the audio mixture 802 includes speech by two speakers, drums, and bass, and the audio tagging and source counting system 804 identifies the presence in the mixture of speech by two speakers, drums, and bass. Based on these identified signals, the list of prompts 806 is created, which includes prompts for speech 808, speech 810, drums 812, and bass 814, and is passed to the audio processing system 102 together with the audio mixture 802. The audio processing system 102 provides as output, the separated audio signals corresponding to speaker 1 816, speaker 2 818, drums 820, and bass 822.

In some embodiments, the audio processing system 102 executes a method for performing audio tasks.

FIG. 9 illustrates a flow chart depicting a method 900 for target sound sources extraction according to various embodiments of the present disclosure. FIG. 9 is explained in conjunction with all the preceding figures. The method 900 is performed by the audio processing system 102. The flow chart initiates at step 902. Following step 902, at step 904, the method 900 includes producing features of the audio mixture 104 formed by multiple sound sources. For example, the audio processing system 102 collects the audio mixture 104 at the audio input interface 118, which processes the audio mixture 104 as per the various embodiments described above.

At step 906, the method 900 includes producing a set of input digital encodings representing input sound prompts of at least some of the sound sources forming the audio mixture 104 in a space of the features of the audio mixture 104. For example, the prompt input interface 120 produces the set of input digital encodings 120a which includes the set of target digital encodings 120b representing target sound prompts 107 for extracting target sound sources from the audio mixture 104.

The method further involves, at step 908, modifying the target digital encodings and the features derived from the audio mixture based on the interaction between the input digital encodings and the derived features. The modification process may involve self-attention mechanisms, feature transformations, or conditioning techniques to enhance the target source representations. For example, the information exchanger neural network 108 is configured to modify the target digital encodings 120b and the features derived from the audio mixture 104, to provide modified target digital encodings 206 and modified features 208. The modified target digital encodings 206 and the modified features 208 are then processed to extract, at step 910, a varying number of target sound sources, where the number of extracted sources depends on the number of designated target sound prompts. For example, the extraction neural network 110 is configured to extract the varying number of target sound sources. The extracted sources are then outputted, at step 912, as individual audio signals, separated from the original mixture. The method 900 terminates at 914.

In certain implementations, the modified features derived from the audio mixture 104 are processed using a Conditional Target Sound Extraction (TSE) module, which is conditioned on each of the modified target digital encodings. The TSE module is designed to extract individual sound sources corresponding to the target sound prompts 107 while suppressing non-target background elements. In some cases, the TSE module is executed multiple times for different modified target digital encodings, allowing the audio processing system 102 to iteratively extract and output multiple sound sources.

In an embodiment, the method 900 may also involve concatenating embeddings of the input sound prompts with the features derived from the audio mixture 104. This concatenation generates a concatenated feature vector, which can be further processed using deep learning models to improve extraction accuracy. Additionally, modifying the target sound prompts and the extracted features may involve executing a self-attention operation, enabling the model to refine its focus on the relevant acoustic components associated with each target source.

In some embodiments, the method 900 includes an encoding step, which is performed by the encoder 124, wherein the features derived from the audio mixture 104 are obtained based on an encoding operation applied to the audio mixture 104. The encoder 124 is described in FIG. 2A and FIG. 3A.

Furthermore, when the input set of sound prompts includes multiple sound prompts, each prompt within the set may be designated as a target sound prompt, allowing the system to manage different extraction scenarios, such as single-source extraction or multi-source separation. The disclosed method 900 can be implemented in various applications, including speech separation, music source decomposition, noise reduction, and audio forensics, and may be deployed on edge devices, cloud-based systems, or real-time audio processing platforms.

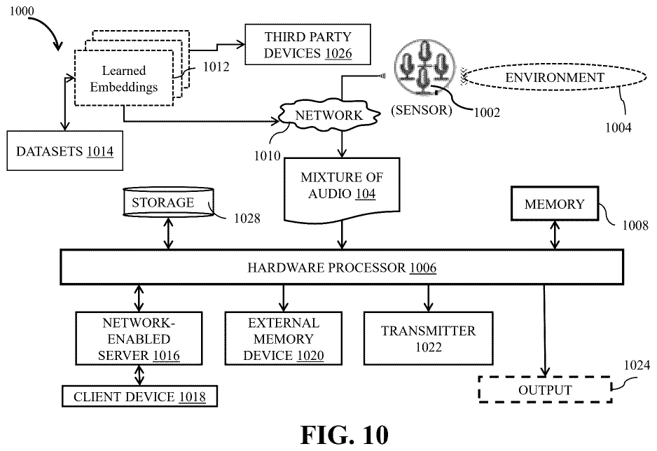

FIG. 10 is a block diagram 1000 of a computing system that is used to implement the audio processing system 102 for performing audio signal processing, according to embodiments of the present disclosure. In some example embodiments, the block diagram 1000 includes an acoustic sensor 1002 or sensors that collect data including the audio mixture 104 from an environment 1004.

The audio processing system 102 includes a hardware processor 1006. The hardware processor 1006 is in communication with a computer storage memory, such as a memory 1008. The memory 1008 includes stored data, including algorithms, instructions and other data that is implemented by the hardware processor 1006. It is contemplated that the hardware processor 1006 includes one or more hardware processors depending upon the requirements of the specific application. The two or more hardware processors is either internal or external. The audio processing system 102 is incorporated with other components including output interfaces and transceivers, among other devices.

In some alternative embodiments, the hardware processor 1006 is connected to a network 1010, which is in communication with one or more sources to receive learned embeddings corresponding to the input prompts 106. The learned embeddings 1012 may be obtained from one or more datasets 1014. The network 1010 includes but is not limited to, by non-limiting example, one or more local area networks (LANs) and/or wide area networks (WANs). The network 1010 also includes enterprise-wide computer networks, intranets, and the Internet. The audio processing system 102 includes one or more client devices, storage components, and data sources. Each of the one or more client devices, storage components, and data sources comprise a single device or multiple devices cooperating in a distributed environment of the network 1010.

In some other alternative embodiments, the hardware processor 1006 is connected to a network-enabled server 1016 connected to a client device 1018. The network-enabled server 1016 corresponds to a dedicated computer connected to a network that run software intended to process client requests received from the client device 1018 and provide appropriate responses on the client device 1018. The hardware processor 1006 is connected to an external memory device 1012 that stores all necessary data used by the audio processing system 102, and a transmitter 1022. The transmitter 1022 helps in transmission of data between the network-enabled server 1016 and the client device 1018. Further, an output 1024 for one or more separated target sound sources is generated.

The audio processing system 102 also includes third party devices 1026, which comprise of any type of computing device, such as automatic speech recognition (ASR) system. For example, the third-party devices include but not limited to a computer device, or a mobile device. The mobile device includes but is not limited to a personal data assistant (PDA), a smartphone, smart watch, smart glasses (or other wearable smart device), augmented reality controller headset, a laptop, a tablet, a remote control, an entertainment system, a vehicle computer system, an embedded system controller, an appliance, a home computer system, a security system, a consumer electronic device, or other similar electronics device. In addition, the mobile device includes but is not limited to a microphone or line-in for receiving audio information, or a communication component (e.g., Wi-Fi functionality) for receiving such information from another source, such as the Internet.

Additionally, the audio processing system 102 stores the input data in the storage 1028. The storage 1028 stores information including data, computer instructions (e.g., software program instructions, routines, or services).

The above description provides exemplary embodiments only and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the above description to provide a thorough understanding of the embodiments. However, understood by one of the ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of several suitable programming languages and/or programming or scripting tools and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described concerning certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. An audio processing system configured to isolate and extract a varying number of sound sources from an audio mixture, the audio processing system comprising a processor coupled with stored instructions that, when executed by the processor, run modules of the audio processing system, the modules comprising:
an audio input interface configured to produce features of an audio mixture formed by multiple sound sources;
a prompt input interface configured to produce a set of input digital encodings representing input sound prompts of at least some of the sound sources forming the audio mixture in a space of the features of the audio mixture, wherein the set of input digital encodings includes a set of target digital encodings representing target sound prompts for extracting target sound sources from the audio mixture;
an information exchanger neural network trained to modify each of the set of target digital encodings, and the features of the audio mixture based on the input digital encodings and the features of the audio mixture;
an extraction neural network trained to extract a varying number of the target sound sources by processing the modified target digital encodings and the modified features of the audio mixture; and
an output interface configured to output the extracted target sound sources.

2. The audio processing system of claim 1, wherein each of the input sound prompts includes one or a combination of a learned embedding vector indicative of a reference sound sample, a recording of a reference sound sample, and a sound event class to indicate one or a group of the multiple sound sources.

3. The audio processing system of claim 1, wherein the information exchanger neural network comprises an attention mechanism such that the information exchanger neural network is trained to place each of the set of input digital encodings and the features of the audio mixture in attention to each of the set of input digital encodings and the features of the audio mixture to modify all of the target digital encodings and the features of the audio mixture.

4. The audio processing system of claim 1, wherein the extraction neural network is configured to process the modified features of the audio mixture with a conditional target sound extraction (TSE) module conditioned separately on each of the modified target digital encodings.

5. The audio processing system of claim 4, wherein the conditional TSE module is executed multiple times for different modified target digital encodings to extract and output multiple sound sources.

6. The audio processing system of claim 1, wherein the extraction neural network is configured to process the modified features derived from the audio mixture with a conditional target sound extraction (TSE) module conditioned on all of the modified target digital encodings.

7. The audio processing system of claim 1, wherein each of the information exchanger neural network and the extraction neural network includes a neural network having a TF-Locoformer architecture.

8. The audio processing system of claim 1, wherein the processor is configured to combine the set of input digital encodings, and the features of the audio mixture to generate a tensor.

9. The audio processing system of claim 1, wherein the information exchanger neural network comprises a self-attention module.

10. The audio processing system of claim 1, wherein the input sound prompts include multiple sound prompts, and each sound prompt is indicated as one of the target sound prompts.

11. The audio processing system of claim 1, wherein the input sound prompts include multiple sound prompts, and a strict subset of the input sound prompts is indicated as the target sound prompts.

12. The audio processing system of claim 1, wherein the features of the audio mixture are in a time-frequency domain, wherein the features at each time frame and each frequency bin comprise a vector of a same dimension as each one of the input digital encodings, such that the information exchanger neural network processes the features of the audio mixture.

13. The audio processing system of claim 1, wherein the audio processing system is trained based on a loss associated with ground truth audio signals and separated signals, such that the loss is computed as a sum of losses for each source category in a set of source categories of the target sound prompts, wherein the loss for each source category is a permutation-invariant loss.

14. The audio processing system of claim 1, further comprising:
a prompt selection model configured to select prompts from a predetermined set of allowed sound prompts for training the audio processing system;
an example selector configured to randomly sample audio samples from datasets stored in a database, wherein the audio samples are determined based on a type of each prompt in the input sound prompts; and
a mixture creator configured to mix the randomly sampled audio samples to create an input mixture.

15. The audio processing system of claim 1, wherein the set of input digital encodings is stored in a memory.

16. The audio processing system of claim 1, wherein the set of input digital encodings is received from a remote device.

17. The audio processing system of claim 1, wherein the prompt input interface comprises a user interface (UI) including a plurality of display options, the plurality of display options comprising at least:
a first UI element associated with a selection of an audio signal;
a second UI element associated with a selection of the input set of sound prompts; and
a third UI element associated with a selection of the target set of sound prompts.

18. A method for processing an audio mixture, comprising:
producing features of the audio mixture formed by multiple sound sources;
producing a set of input digital encodings representing input sound prompts of at least some of the sound sources forming the audio mixture in a space of the features of the audio mixture, wherein the set of input digital encodings includes a set of target digital encodings representing target sound prompts for extracting target sound sources from the audio mixture;
modifying the target digital encodings and the features derived from the audio mixture based on the input digital encodings and the features of the audio mixture;
extracting a varying number of the target sound sources by processing the modified target digital encodings and the modified features of the audio mixture; and
outputting the extracted target sound sources.

19. The method of claim 18, further comprising:
executing an operation, the operation comprising placing each of the set of input digital encodings and the features of the audio mixture in attention to each of the set of input digital encodings, and the features derived of the audio mixture; and
modifying each of the set of target digital encodings and the features of the audio mixture based on the execution of the operation, to obtain modified target digital encodings and modified features of the audio mixture.

20. The method of claim 19, wherein the modification of each of the set of target digital encodings and the features of the audio mixture comprises executing a self-attention operation.
